(19) United States
(12) Patent Application Publication
(10) Pub. No.: US 2006/0187863 A1
(43) Pub. Date: Aug. 24, 2006

(54) System and method for operating a wideband return channel in a bi-directional optical communication system

(75) Inventors: John J. Kenny, Suwanee, GA (US); James O. Farmer, Cumming, GA (US)

Correspondence Address: KING & SPALDING LLP, 1180 PEACHTREE STREET, ATLANTA, GA, 30309, US

(73) Assignee: Wave7 Optics, Inc., Alpharetta, GA (US)

(21) Appl. No.: 11/316,423

(22) Filed: Dec. 21, 2005

Related U.S. Application Data
(60) Provisional application No. 60/637,998, filed on Dec. 21, 2004.

(51) Int. Cl. H04L 5/16

(52) U.S. Cl. 370/296

(57) ABSTRACT

An inventive system capable of being utilized in environments where laser transceiver nodes may be subject to extreme temperatures. Temperature changes in the laser transceiver nodes may be compensated for by utilizing a wide wavelength channel allocation for data sent upstream from the laser transceiver nodes to the data service hub. The wavelength channel allocations for upstream data may be wider than the wavelength channel allocations for downstream data. An exemplary embodiment of the inventive system may comprise a data service hub connected to one or more laser transceiver nodes by one or more optical waveguides. Some embodiments with multiple optical waveguides are capable of practicing route redundancy. According to an exemplary embodiment of the inventive system, the optical waveguides are capable of carrying multiple optical signals at different wavelengths in order to serve a plurality of laser transceiver nodes.

### STATEMENT REGARDING PRIORITY AND RELATED APPLICATIONS

The present application claims priority under 35 U.S.C. §119(e) based upon U.S. Provisional Patent Application No. 60/637,998 entitled, “Wideband Return Optical Channel,” filed on Dec. 21, 2004. Additionally, the present application is related to U.S. non-provisional patent application entitled, “System and Method for Communicating Optical Signals Upstream and Downstream Between a Data Service Provider and Subscribers”, filed on Aug. 19, 2004 and assigned U.S. application Ser. No 10/921,489. The complete disclosure of the above-identified priority application and related application is hereby fully incorporated herein by reference.

### TECHNICAL FIELD

The present invention relates to video, voice, and data communications. More particularly, the present invention relates to a system and method for propagating optical signals between a data service hub and a laser transceiver node, wherein the laser transceiver node is potentially subject to extreme temperatures.

### BACKGROUND OF THE INVENTION

The increasing reliance on communication networks to transmit more complex data, such as voice and video traffic, is causing a very high demand for bandwidth. To resolve this demand for additional bandwidth, conventional communication architectures that employ coaxial cables are slowly being replaced with communication networks that comprise only fiber optic cables. This is because optical fibers may carry greater amounts of information than coaxial cables.

U.S. Pat. No. 6,973,771, filed on Jul. 5, 2001 and hereby incorporated herein by reference, discloses a optical fiber communications network system for distributing video, voice and data signals to subscribers through the use of an optical waveguide terminating at a subscriber's residence. Such a system involves at least three elements a data service hub, a laser transceiver node, and a subscriber optical interface. A data service hub formats signals and communicates them to a laser transceiver node. The laser transceiver, in turn, further formats the signals and forwards them to a subscriber optical interface. The subscriber optical interface converts downstream optical signals to electrical signals and upstream electrical signals to optical signals.

The laser transceiver node may be proximate to subscribers or may reside in the data service hub. In certain cases, a plurality of laser transceiver nodes will be located in a location outside of the data service hub and proximate to a group of subscribers. In other cases, it is desirable to provide a plurality of data interfaces on optical waveguides to a single laser transceiver node in order to provide for more data capacity. These plurality of data interfaces may be a plurality of Gigabit Ethernet interfaces, which together provide for more subscriber bandwidth than can be provided with a single interface. For example, in one embodiment, a laser transceiver node serves 96 subscribers with a total bandwidth capability of three Gigabytes per second (3 Gb/s). If it is connected to the data service hub via a single Gigabit Ethernet connection, only 1 Gb/s of the total of 3 Gb/s can be used at one time because that is the limit of the single Gigabit Ethernet connection. However, if at least three Gigabit Ethernet connections are provided, the full subscriber bandwidth may be used. In both cases, however, multiple optical waveguides are normally utilized to connect the laser transceiver node(s) to the data service hub.

Further, it is often desirable to route the plurality of optical waveguides along diverse physical paths between the data service hub and the laser transceiver node(s). By doing so, if one cable is accidentally cut, the other cable can carry traffic until the damaged cable can be repaired. This is referred to as redundancy and, because it involves different routing of optical waveguides, it may be referred to as route redundancy. Similar to route redundancy is equipment redundancy, in which a piece of equipment on either end can take over for a failed piece of equipment until repairs are made.

As is understood by one of ordinary skill in the art, a single optical waveguide or a single pair of optical waveguides may carry multiple signals if each is carried at a unique wavelength. To achieve this result, a standard set of wavelengths has been defined by the International Telecommunications Union (ITU). FIG. 1 illustrates the standard ITU wavelength allocations for optical transmission. Channels are spaced every 20 nanometers (nm), and in order to allow for filter transition regions, passband filters that are about 13 nm wide are used to separate the wavelengths. Thus, for the normal ITU plan to work, an optical transmitter must keep the wavelength of the transmitted signal within this 13 nm wide window. As will be explained below, this is not a problem if the equipment is temperature controlled, however, in uncontrolled temperatures, an optical transmitter may not be able to transmit within this window.

In most, if not all instances, the data service hub is environmentally controlled to temperatures conducive to human occupation. This usually means a temperature range of less than 0° to 50° C. This temperature range is suitable for the operation of most equipment housed at the data service hub. For example, components are usually specified to operate over a temperature range of 0 to +70° C. Accordingly, an optical transmitter located within the data service hub does not need to operate over a particularly wide temperature range since it is within a temperature controlled environment.

Laser transceiver nodes, however, are often not disposed within a temperature regulated enclosure. In some instances, laser transceiver nodes are preferably located in the field, either mounted on a stand near a telephone pole, as is often practiced with cable television equipment, or in an unheated cabinet beside the road. Thus, the corresponding optical transmitter located within the laser transceiver node may be subject to a wider temperature variation. For example, temperatures that the laser transceiver node may be subjected to can range from −40° to +60° C. This is representative of the environmental extremes encountered in most places on earth. However, because of the internal temperature rise associated with equipment, the actual temperature range over which the optical transmitter is likely to operate is between −40° to +85° C. Therefore, it is desirable to design the optical transmitter so that it may operate over a wide range of temperatures; specifically, it is desirable that an optical transmitter in the laser transceiver node at least be capable of operating over temperature ranges of −40 to +85° C.

With this extreme temperature range, a problem may occur during the transmission of optical signals from an optical transmitter. This problem is known as wavelength drift. FIG. 2 is a graph that illustrates the temperature dependency of conventional optical transmitters. Temperature is plotted on the X-axis and wavelength is plotted on the Y-axis. On the temperature axis, Tc, Ta, Tb, and Td are plotted, where Tc represents −40° C., Ta represents 0° C., Th represents 70° C., and Td represents 85° C. A line 205 is then plotted with a slope of 0.1 nm per degrees Celsius. This represents the wavelength variance, or “drift,” associated with a change in temperature. From this slope, lines 210 are drawn from the specified temperature to a corresponding wavelength to determine the amount of drift associated with that temperature.

As is understood by one of ordinary skill in the art, an optical waveguide transceiver within a laser transceiver node comprises an optical transmitter and optical receiver. Therefore, as can be seen from FIG. 2, a wavelength transmitted from the optical transmitter of an optical waveguide transceiver located in a laser transceiver node will drift drastically when subject to an extreme temperature range. Specifically, over the temperature range of −40 to +85 C, the wavelength generated by the optical waveguide transceiver can vary about 12.5 nm. This is because there is a 125 degree spread between −40 to 85 degrees and, as is illustrated in FIG. 2, the wavelength varies by 0.1 nm/degree Celsius. Thus, coupling the variance of 12.5 nm with an initial wavelength tuning tolerance of ±2 nm (which includes the fact that laser wavelengths may not be specified exactly in the middle of the temperature range), leads to a total wavelength spread of about 16.5 nm for a laser transceiver node subjected to these temperatures.

As stated above, ITU specifies channel filters to be approximately 13 nm wide. Thus, because of the wavelength drift associated with extreme temperatures, optical transmitters located within the optical waveguide transceiver of a laser transceiver node may project signals outside of the ITU wavelength allocations. In these instances, transmissions from the laser transceiver node to the data service hub may be lost or distorted. For this reason, conventional techniques require that the laser transceiver node be placed in a controlled temperature environment, thereby raising the cost and maintenance associated with implementing an optical network.

Accordingly, there presently exists a need in the art for a system and method for communicating optical signals between a data service provider and a subscriber that is capable of operating over a wide range of temperatures in order to compensate for optical wavelength drift. Specifically, there exists a need in the art for utilizing laser transceiver nodes in the field without requiring that the laser transceiver node be temperature regulated.

### SUMMARY OF THE INVENTION

The present invention solves the aforementioned problems by providing a method and system for implementing an optical network wherein the laser transceiver nodes do not need to be temperature regulated. Also, the inventive system may provide route and equipment redundancy. Further, the inventive system is also capable of providing a novel and unconventional way for avoiding the cost and implementation problems associated with broadcasting RF data to a subscriber.

According to another exemplary embodiment, the inventive system is capable of being utilized in environments where laser transceiver nodes may be subject to extreme temperatures. According to one exemplary embodiment of the inventive system, temperature changes in the laser transceiver nodes are compensated for by utilizing a wide wavelength channel allocation for data sent upstream from the laser transceiver nodes to the data service hub. According to this embodiment, the wavelength channel allocations for upstream data (i.e., data propagating from the laser transceiver nodes to the data service hub) are wider than the wavelength channel allocations for downstream data (i.e., data propagating from the data service hub to the laser transceiver nodes).

An exemplary embodiment of the inventive system may comprise a data service hub connected to one or more laser transceiver nodes by one or more optical waveguides. Some embodiments with multiple optical waveguides are capable of practicing route redundancy. According to an exemplary embodiment of the inventive system, the optical waveguides are capable of carrying multiple optical signals at different wavelengths in order to serve a plurality of laser transceiver nodes. In addition, the inventive system may also provide for greater data capacity through the use of multiple waveguides to a single laser transceiver nodes.

The inventive system may further comprise a multiplexer/demultiplexer (MUX/DEMUX) and a Drop/Add (D/A) device. The MUX/DEMUX may be designed to combine and filter unconventional wavelength widths as well as ITU standard wavelength channel widths. Similarly, the D/A device may be designed to filter unconventional wavelength widths or standard wavelength channel widths. In an exemplary embodiment, the unconventional wavelength widths may be greater than the ITU standard channel widths.

Accordingly, the inventive system can comprise a system whereby laser transceiver nodes can communicate to the data service hub along optical waveguides utilizing channel widths greater than conventional standards. In concert with this, the data service hub can be capable of transmitting optical signals to the laser transceiver node via the same, or a different, optical waveguide utilizing wavelength channel widths less than those utilized by the laser transceiver node. These wavelength channel widths may be, or may not be, the ITU standard width. In any event, the wavelength channel widths utilized by the laser transceiver node in the upstream (i.e., data sent to the data service hub) direction may be equal to or greater than the channel widths utilized by the optical transmitters of the data service hub in the downstream (i.e., data sent from the data service hub) direction.

In one embodiment, where downstream data and upstream data are communicated to and from the data service hub and one or multiple laser transceiver nodes via separate optical waveguides, the inventive system may further comprise a broadcast optical transmitter for transmission of RF data to a subscriber. In this embodiment, the broadcast optical signal may be multiplexed in combination with the wideband upstream data. This combination can reduce or substantially eliminate the problem of Raman Scattering without requiring the use of an additional waveguide.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is an illustration of a wavelength allocation plan according to the ITU standard.

FIG. 2 is a graph illustrating the change in wavelength of a signal transmitted by an optical transmitter over a range of temperatures according to an exemplary embodiment of the present invention.

FIG. 3 is a functional block diagram illustrating an exemplary optical network architecture for the present invention.

FIG. 4 is a functional block diagram illustrating a data service hub according to an exemplary embodiment of the present invention.

FIG. 5 is a functional block diagram illustrating a laser transceiver node according to an exemplary embodiment of the present invention.

FIG. 6 is an illustration of a wavelength allocation plan according to an exemplary embodiment of the present invention.

FIGS. 7A-E illustrate a Drop/Add device (D/A device) according to an exemplary embodiment of the present invention.

FIGS. 8A-C illustrate a multiplexer/de-multiplexer (MUX/DMUX) according to an exemplary embodiment of the present invention.

FIGS. 9A-B illustrate a functional block diagram and wavelength allocation plan, respectively, according to an exemplary embodiment of the present invention.

FIGS. 10A-B illustrate a functional block diagram and wavelength allocation plan, respectively, according to an exemplary embodiment of the present invention.

FIGS. 11A-B illustrate a functional block diagram and wavelength allocation plan, respectively, according to an exemplary embodiment of the present invention.

FIGS. 12A-B illustrate a functional block diagram and wavelength allocation plan, respectively, according to an exemplary embodiment of the present invention.

FIGS. 13A-B illustrate a functional block diagram and wavelength allocation plan, respectively, according to an exemplary embodiment of the present invention.

FIGS. 14A-B are logic flow diagrams illustrating a method of transmitting data between a temperature regulated data service hub and a temperature deregulated laser transceiver node according to an exemplary embodiment of the present invention.

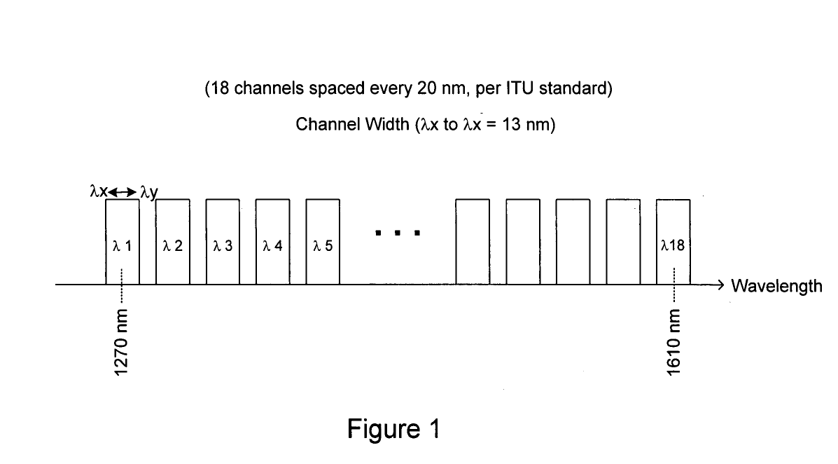

### DETAILED DESCRIPTION OF THE EXEMPLARY EMBODIMENTS

The present invention provides a novel and unconventional method and system for implementing an optical network wherein the laser transceiver nodes do not need to be temperature regulated. Additionally, the inventive system may provide route and equipment redundancy. Further, the inventive system is also capable of providing a novel and unconventional way for avoiding the cost and implementation problems associated with broadcasting RF data to a subscriber.

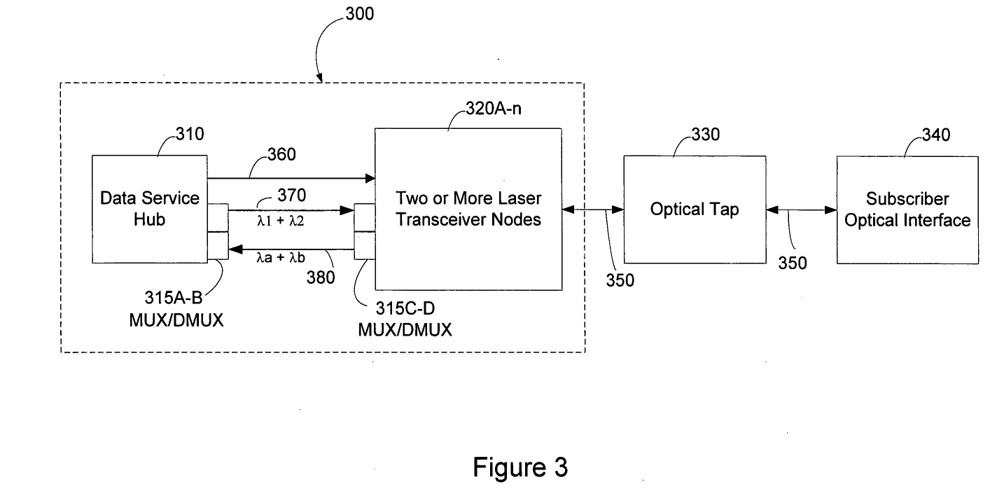

FIG. 3 illustrates an optical network system as disclosed in U.S. Pat. No. 6,973,771, the entire contents of which are hereby incorporated herein by reference. Data and radio frequency (RF) video signals originate at a data service hub 310 and are transmitted to a plurality of laser transceiver nodes 320, only one of which is shown. The laser transceiver node 320 performs certain formatting operations on the data, and transmits it to a plurality of optical taps 330, each of which divides the optical signal to serve a plurality of subscriber optical interfaces 340. Data and video signals may be carried between data service hub 310 and the laser transceiver nodes 320 on one or more optical waveguides 360, 370, 380.

According to one embodiment, three optical waveguides are utilized. It is noted that the term “optical waveguide” used in the present application can apply to optical fibers, planar light guide circuits, and fiber optic pigtails and other like optical waveguides. First optical waveguide 360 may carry broadcast video downstream to the laser transceiver node 320. Second optical waveguide 370 may carry data downstream to the laser transceiver node 320, and third optical waveguide 380 may carry data upstream from the laser transceiver node 320 to the service hub 310. As illustrated in FIG. 3, second optical waveguide 370 and third optical waveguide 380 are each shown carrying two wavelengths (i.e., wavelengths λ1 and λ2 on waveguide 370 and wavelengths λa and λb on waveguide 370); however, the number of wavelengths on these waveguides 370, 380 is for exemplary purposes only. Accordingly, one of ordinary skill in the art understands that the number of wavelengths on a particular optical waveguide may vary depending on the use of the waveguide. In addition to the above, yet another optical waveguide 350 is illustrated in FIG. 3. This optical waveguide 350 carries signals from the laser transceiver node 320 to the subscriber optical interface 340 by way of an optical tap 330.

The inventive system 300 illustrated in FIG. 3 is outlined by a rectangle. Accordingly, the inventive system 300 comprises a data service hub 310, at least one multiplexer/demultiplexer (MUX/DMUX) 315A-D, and two or more laser transceiver nodes 320A-n connected by one or more optical waveguides 360, 370, 380. A preferred protocol for use on the data communications path between the data service hub 310 and the laser transceiver nodes 320A-n is Gigabit Ethernet, as is well understood by one of ordinary skill in the art. However, other protocols such as asynchronous transfer mode (ATM) may be used without departing from the scope and spirit of the present invention. Further, while the MUX/DMUX 315A-D are illustrated in the inventive system 300 as being located outside of the data service hub 310 and laser transceiver nodes 320, it is well understood by one of ordinary skill in the art that the MUX/DMUX 315A-D could be located within either or both of the devices as would be called for under the circumstances. Thus, their location should not be construed as a limitation of the present invention.

In alternative exemplary embodiments discussed herein, the data service hub 310 and laser transceiver nodes 320A-n, where “n” represents the last of a particular functional element, may be connected by one, two or three optical waveguides 360, 370, 380. Accordingly, one of ordinary skill in the art will know that any number of data service hubs 310, laser transceiver nodes 320A-n, and optical waveguides 360, 370, 380, may be utilized without departing from the spirit and scope of the present inventive system and method.

It should be noted that the designation “n” in the text and figures herein refers to the last functional element in a particular series of functional elements. In this way, the text and figures express that any number of similar elements may be utilized without leaving the scope and spirit of the present invention. Further, while the system and method disclosed herein primarily concerns the movement of data and video signals between the data service hub 310 and the laser transceiver nodes 320A-n, it is understood by one of ordinary skill in the art that this system and method may be employed in other similar systems, as well as other portions of the optical network system, as may be needed to correct the problems addressed herein. For example, the inventive system 300 may be employed to address the exchange of data between the laser transceiver nodes 320 and multiple optical taps 330. Thus, the present invention is not limited to the specific embodiments and examples disclosed herein.

As is illustrated in FIG. 3, optical signals originate in the data service hub 310, are multiplexed, or combined, by a MUX/DMUX 315A (as will be described in greater detail below) and are propagated downstream on a first optical waveguide 370. Downstream, the optical signals are demultiplexed, or separated, by a MUX/DMUX 315B and a separate signal enters each of the laser transceiver nodes 320A-n. Similarly, in the upstream direction, each of the laser transceiver nodes 320A-n transmits an optical signal which is multiplexed, together with the other laser transceiver node 320 signals, by a MUX/DMUX 315C and then propagated upstream on a second optical waveguide 380. The signals are then demultiplexed by a MUX/DMUX 315D and received by the data service hub 310. Additionally, video signals may be propagated by the data service hub 310 and may be received by the laser transceiver nodes 320 a-n via a third optical wave guide 380.

According to the inventive system 300 illustrated in FIG. 3, temperature changes in the laser transceiver nodes 320A-n may be compensated for by utilizing a wide wavelength channel allocation for data sent upstream from the laser transceiver nodes 320A-n to the data service hub 310. According to this embodiment, the wavelength channel allocations for upstream data (i.e., data propagating from the laser transceiver nodes to the data service hub) are wider than the wavelength channel allocations for downstream data (i.e., data propagating from the data service hub to the laser transceiver nodes).

In FIG. 3, wavelengths identified by numbers (e.g., λ1, λ2, λ3, etc.) are downstream wavelengths that are associated with a first wavelength channel allocation. Conversely, upstream wavelengths in FIG. 3 are identified by letters (e.g., λa, λb, λc, etc.), and are specified at a second wavelength channel allocation in which the channels in this channel allocation are wider than those in the first wavelength channel allocation. Thus, for example, downstream wavelengths on optical waveguide 370 may have a channel allocation according to the ITU standard, i.e., channel widths of 13 nm, while, as will be discussed in more detail in reference to the exemplary embodiments disclosed herein, upstream wavelengths may have channel widths of approximately twice the size of the downstream channel widths, i.e., channel widths of 26 nm.

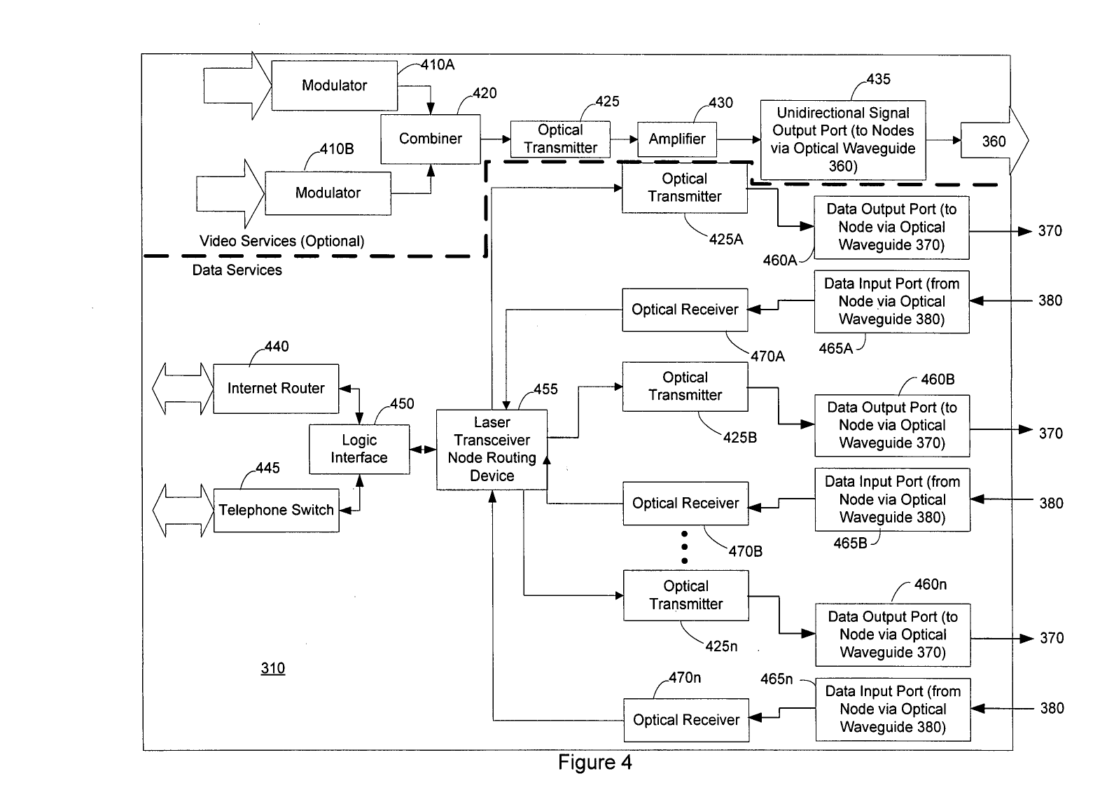

FIG. 4 illustrates the data service hub 310 according to an exemplary embodiment of the inventive system 300. This exemplary embodiment is very similar to one described in U.S. Pat. No. 6,973,771, incorporated herein by reference, however, the present embodiment comprises a data output port 460A-n and data input port 465A-n, as opposed to using a combined input/output port as illustrated in the incorporated application.

Accordingly, the exemplary embodiment illustrated in FIG. 4 comprises one or more sets of optical transmitters 425A-n, optical receivers 470A-n, data output ports 460A-n, and data input ports 465A-n serve each corresponding laser transceiver node 320A-n (not illustrated in FIG. 4) via one or more optical waveguides 360, 370, 380. The optical transmitters 425A-n can comprise standard off-the-shelf analog externally modulated distributed feed back (DFB) laser transmitters, including those manufactured by Synchronous and Scientific-Atlanta. The laser optical transmitters 425 can also comprise one of Fabry-Perot (F-P) Laser Transmitters, and Vertical Cavity Surface Emitting Lasers (VCSELs). However, other types of optical transmitters 425A-n are possible and are not beyond the scope of the present invention.

The input ports 465A-n and output ports 460A-n are connected to one or more first optical waveguides 370, 380 that support optical signals between the data service hub 310 and one or more laser transceiver nodes 320. While the number of input ports 465 and output ports 460 paired with each laser transceiver node 320 (not illustrated in FIG. 4) may be one or more, it is understood by one of ordinary skill in the art that other embodiments may use additional input ports 465, output ports 460, and optical waveguides 360, 370, 380 to transmit data to each laser transceiver node 320 in order to provide increased data bandwidth.

The data service hub 310 may further comprise an Internet router 440. The data service hub 310 can also comprise a telephone switch 445 that supports telephony service to the subscribers of an optical network system. However, other telephony services, such as Internet Protocol telephony, can also be supported by the data service hub 310. If only Internet Protocol telephony is supported by the data service hub 310, then it is apparent to those skilled in the art that the telephone switch 445 could be eliminated in favor of lower cost VoIP equipment. For example, in another exemplary embodiment (not illustrated), the telephone switch 445 could be substituted with other telephone interface devices such as a soft switch and gateway. But if the telephone switch 445 is needed, it may be located remotely from the data service hub 310 and can be connected through any of several conventional means of interconnection.

The data service hub 310 can further comprise a logic interface 450 that is connected to a laser transceiver node routing device 455. The logic interface 450 can comprise a Voice over Internet Protocol (VoIP) gateway when required to support such a service. The laser transceiver node routing device 455 can comprise a conventional router that supports an interface protocol for communicating with one or more laser transceiver nodes 320. This interface protocol can comprise one of gigabit or faster Ethernet and SONET protocols. However, the present invention is not limited to these protocols. Other protocols can be used without departing from the scope and spirit of the present invention.

The logic interface 450 and laser transceiver node routing device 455 can read packet headers originating from the internet router 440. The logic interface 450 can also interface with the telephone switch 445. After reading the packet headers, the logic interface 450 and laser transceiver node routing device 455 can determine where to send the packets of information.

The laser transceiver node routing device 455 can supply downstream data signals to respective laser optical transmitters 425A-n as described above. The data signals can then be converted into optical signals by the laser optical transmitters 425A-n and can then be propagated downstream to corresponding data output ports 460A-n connected to a downstream optical waveguide 370.

Similarly, data can enter data input ports 465A-n from optical waveguide 380 and be propagated to optical receivers 470A-n, wherein the signals are re-converted to electrical form. The optical receivers 470A-n then propagate the converted signals to the laser transceiver node routing device 455 which, in turn, propagates the signals to the logic interface 450. The logic interface 450 and laser transceiver node routing device 455 can read the signals to determine which device the signals are intended for. Thus, certain data may be forwarded to the internet router 440 and other data may be forwarded to the telephone switch.

The data service hub 310 may also have the added capability of sending RF video signals to each linked laser transceiver node 320. If enabled as such, the data service hub 310 would further comprise the components illustrated in the upper portion of FIG. 4 separated from the bottom portion of the figure by a heavy dotted line. Specifically, the data service hub 310 would comprise one or more modulators 410A-B designed to support television broadcast services. The one or more modulators 410A-B can be analog or digital type modulators. Those skilled in the art will appreciate that the number of modulators 410A-B can be varied without departing from the scope and spirit of the present invention. Thus, in one exemplary embodiment (not illustrated), there may be 78 or more modulators present in the data service hub 310.

The signals from the modulators 410A-B are combined in a combiner 420 where they are supplied to an optical transmitter 425. The radio frequency signals generated by the modulators 410A-B are converted into optical form in the optical transmitter 425. From here, the optical RF video signal is propagated to an amplifier 430, such as an Erbium Doped Fiber Amplifier (EDFA), where the RF video optical signal is amplified. The amplified signal is then propagated out of the data service hub 310 via a unidirectional signal output port 435, which is connected to a third optical waveguide 360. Additionally, other exemplary embodiments disclosed herein allow for the distribution of video signals on the inventive system 300 without requiring the use of a third optical waveguide 360.

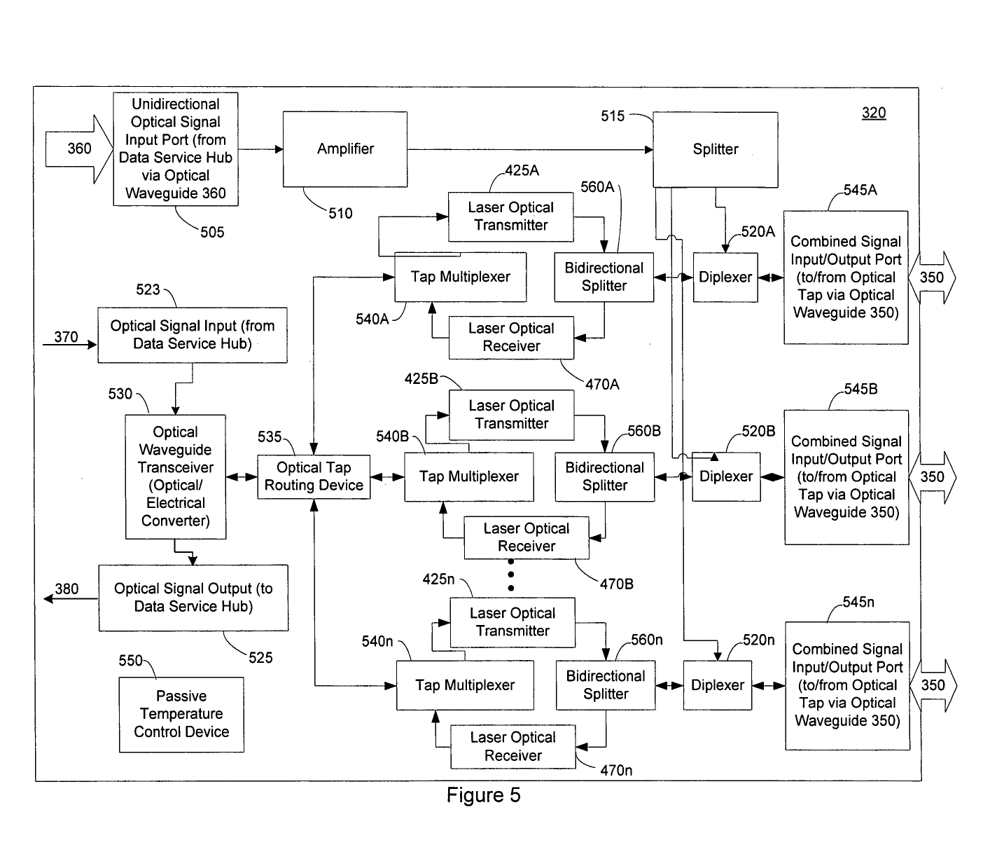

FIG. 5 illustrates an exemplary embodiment of a laser transceiver node 320 according to an exemplary embodiment of the inventive system 300. In this exemplary embodiment, the laser transceiver node 320 can comprise a unidirectional optical signal input port 505 that can receive RF video optical signals propagated from the data service hub 310 along an optical waveguide 360. The RF video optical signals received at the input port 505 are propagated to an amplifier 510, such as an Erbium Doped Fiber Amplifier (EDFA), in which the RF video optical signals are amplified. The amplified optical signals are then split in the splitter 515 such that they may be propagated to multiple combined input/output ports 545A-n and then further propagated downstream to ultimately be received by a subscriber.

The laser transceiver node 320 can further comprise an input port 523 that connects the laser transceiver node 320 to an optical waveguide 370 that supports data flow between the data service hub 310 and the laser transceiver node 320. Downstream optical signals flow through the optical input port 523 to an optical waveguide transceiver 530, which can convert downstream optical signals into the electrical domain. As is understood by one of ordinary skill in the art, the optical waveguide transceiver 530 further comprises an optical receiver 470 (not illustrated in FIG. 5) and an optical transmitter 425 (not illustrated in FIG. 5). Thus, one of ordinary skill in the art understands that the optical transmitter 425 (not illustrated in FIG. 5) that forms a part of the optical waveguide transceiver 530 can convert upstream electrical signals into the optical domain which may then be distributed upstream via an optical waveguide 380 via the output port 525. Similarly, one of ordinary skill in the art understands that the optical receiver 470 (not illustrated in FIG. 5) that also comprises the optical waveguide transceiver 530 may receive optical signals originating from the data service hub 310 and propagating through downstream waveguide 370 via the data input port 523.

The laser transceiver node 320 may also comprise an optical tap routing device 535 and tap multiplexers 540A-n. The optical tap routing device 535 can manage the interface with the data service hub 310 signals and can route or divide or apportion the data service hub 310 signals according to which optical tap 330 (not illustrated in FIG. 5) is to receive the downstream signal, or according to which optical tap 330 originated the upstream signal. More specifically, for downstream signals, the optical tap routing device 535 can manage the interface with the data service hub 310 signals and can route these signals to the corresponding individual optical tap multiplexers 540A-n.

In the upstream direction, the optical tap routing device 535 is notified of available upstream data packets as they arrive by each tap multiplexer 540A-n. The optical tap routing device 535 is connected to each tap multiplexer 540A-n to receive these upstream data packets. The optical tap routing device 535 relays the packets to optical waveguide transceiver 530, which converts the signals into the optical domain and sends them out the output data port 525 and on to the data service hub 310 via an optical waveguide 380.

The optical tap routing device 535 can build a lookup table from these upstream data packets coming to it from all tap multiplexers 540A-n by reading the source IP address of each packet, and associating it with the tap multiplexer 540A-n through which it came. This lookup table can then be used to route packets in the upstream path. Similarly, as each packet comes in from the optical waveguide transceiver 530, the optical tap routing device 535 looks at the destination IP address (which is the same as the source IP address for the upstream packets) and therefrom can determine to which tap multiplexer 540A-n the packet needs to be sent. This can be described as a normal layer three router function as is understood by those skilled in the art.

The optical tap routing device 535 can also assign multiple subscribers to a single port. Thus, the optical tap routing device 535 can determine which tap multiplexers 540A-n are to receive a downstream electrical signal, or identify which of a plurality of tap multiplexers 540A-n propagated an upstream signal. The optical tap routing device 535 can format data and implement the protocol required to send and receive data from each individual subscriber connected to a respective optical tap 330 (not illustrated in FIG. 5). To perform these functions, the optical tap routing device 535 may comprise a computer or a hardwired apparatus that executes a program defining a protocol for communications with groups of subscribers assigned to individual ports. One exemplary embodiment of the program defining the protocol is discussed in commonly assigned provisional patent application entitled, “Method and System for Processing Downstream Packets of an Optical Network,” filed on Oct. 26, 2001 and assigned U.S. application Ser. No. 10/045,652, the entire contents of which are hereby incorporated herein by reference.

With the optical tap routing device 535, the laser transceiver node 320 can adjust a subscriber's bandwidth on a subscription basis or on an as-needed or demand basis. The laser transceiver node 320 via the optical tap routing device 535 can offer data bandwidth to subscribers in pre-assigned increments. For example, the laser transceiver node 320 via the optical tap routing device 535 can offer a particular subscriber or groups of subscribers bandwidth in units of 1, 2, 5, 10, 20, 50, 100, 200, and 450 Megabits per second (Mb/s). Those skilled in the art will appreciate that other subscriber bandwidth units are not beyond the scope of the present invention.

Electrical signals are communicated between the optical tap routing device 535 and respective tap multiplexers 540A-n. The tap multiplexers 540A-n, along with optical transmitters 425A-n and optical receivers 470A-n, propagate optical signals to and from various groupings of subscribers. Each tap multiplexer 540A-n is connected to a respective optical transmitter 425A-n. The optical transmitters 425A-n produce the downstream optical signals that are propagated towards the subscriber optical interfaces 340 (not illustrated in FIG. 5). As noted above, the optical transmitters 425A-n can comprise one or more of the Volgatech SLD series diodes or the SLD-56-MP from Superlum, Ltd.

Each tap multiplexer 540A-n is also coupled to an optical receiver 470A-n. Each optical receiver 470A-n, as noted above, can comprise photoreceptors or photodiodes. Each optical transmitter 425A-n and each optical receiver 470A-n can be connected to a respective bi-directional splitter 560A-n. Each bi-directional splitter 560A-n, in turn, can be connected to a diplexer 520A-n.

The signals propagating from each optical transmitter 425A-n or propagating to each optical receiver 470A-n are combined in the bi-directional splitter 560A-n. The optical signals sent from the optical transmitter 425A-n into the bi-directional splitters 560A-n can then be propagated to the diplexer 520A-n and then towards bi-directional input/output port 545A-n that is connected to another optical waveguide 350 that supports bi-directional optical data signals between the laser transceiver node 320 and a respective optical tap 330 (not illustrated in FIG. 5).

In another exemplary embodiment (not illustrated), the downstream signals propagating from the bi-directional splitters 560A-n can be combined or multiplexed by a MUX/DMUX 315 (as will be described in further detail below). As is known by one of ordinary skill in the art, by propagating information at different wavelengths, one optical waveguide can service a number of individual optical taps 330. For example, an optical signal passing through a MUX/DMUX 315 from a first optical transmitter 425A may be tuned at optical wavelength λa, while the signal passed through a MUX/DMUX 315 from a second optical transmitter 425B may be tuned at optical wavelength λb. Likewise, a signal passed through a MUX/DMUX 315 from an n^{th} transmitter 425n may be tuned at optical wavelength λn. Accordingly, these signals at varying frequencies may exit the laser transceiver node 320 through bi-directional input/out ports 545A-n, be multiplexed or combined in the MUX/DMUX 315, and then propagated along one optical waveguide 350 to multiple optical taps 330. In this way, the wideband channels of the inventive system 300 may be utilized to propagate the signals downstream to the multiple optical taps 330.

Comparing FIGS. 4 and 5 in relation to one another better illustrates how data might flow between a data service hub 310 and a laser transceiver node 320. To transmit data in the downstream direction, a signal may originate in the data service hub 310 at the optical transmitter 425A and pass through the data output Port 460A and then into the optical waveguide 370. At the laser transceiver node 320, the signal may pass from the downstream optical waveguide 370 to the optical signal input 523 and then to the optical waveguide transceiver 530.

The optical waveguide transceiver 530, utilizing an optical receiver, converts the signal from an optical to an electrical signal and forwards the signal to the optical tap routing device 535. The optical tap routing device 535 then routes the signals to multiple tap multiplexers 540A-n. Each signal is then sent to a laser optical transmitter 425, so that it may be converted from an electrical to an optical signal and then transmitted to a splitter 560, diplexer 520A, and finally to a combined signal input/output port 545. From here, the optical signal is sent downstream to a subscriber located at an optical tap 330 (not illustrated in FIG. 5) via an optical waveguide 350.

In the upstream direction, a signal may optically originate in the optical waveguide transceiver 530 of the laser transceiver node 320, pass through optical signal output 525 and into the upstream optical waveguide 380. The signal subsequently may enter the data service hub 310 on data input port 465A and terminate at optical receiver 470A, where the signal is reconverted to electrical form. In concurrence with the above, a video signal may also be transferred from the data service hub 310 to the laser transceiver node 320 on a separate optical waveguide 360. Alternatively, as will be discussed in detail below, a video signal may be transferred downstream on upstream optical waveguide 380.

U.S. Pat. No. 6,973,771, which is incorporated herein by reference, describes in greater detail how the data service hub 310 and laser transceiver node 320 process data and video signals, as well as how those signals are ultimately routed to the subscriber. The inventive system 300 disclosed herein, however, is primarily concentrated on data flow between the data service hub 310 and the laser transceiver node 320. Thus, while the inventive system 300 may be utilized by one of ordinary skill in the art for other configurations, subsequent figures herein illustrate signals originating and terminating between the data service hub 310 and laser transceiver node 320 without reference to the internal movement of data or the movement of data outside of the two components of the optical network.

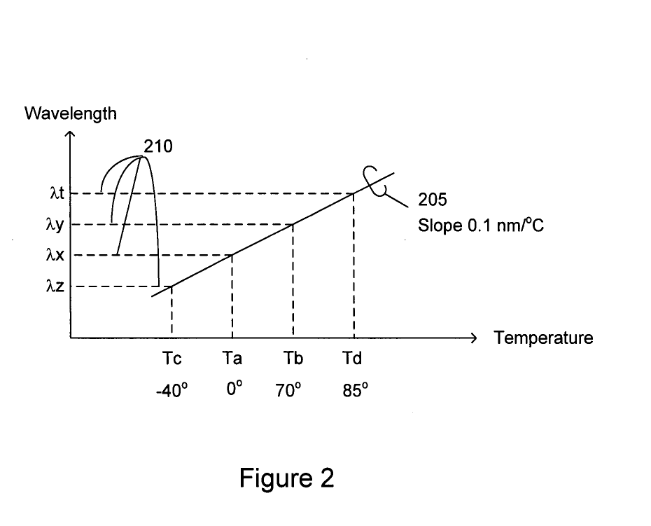

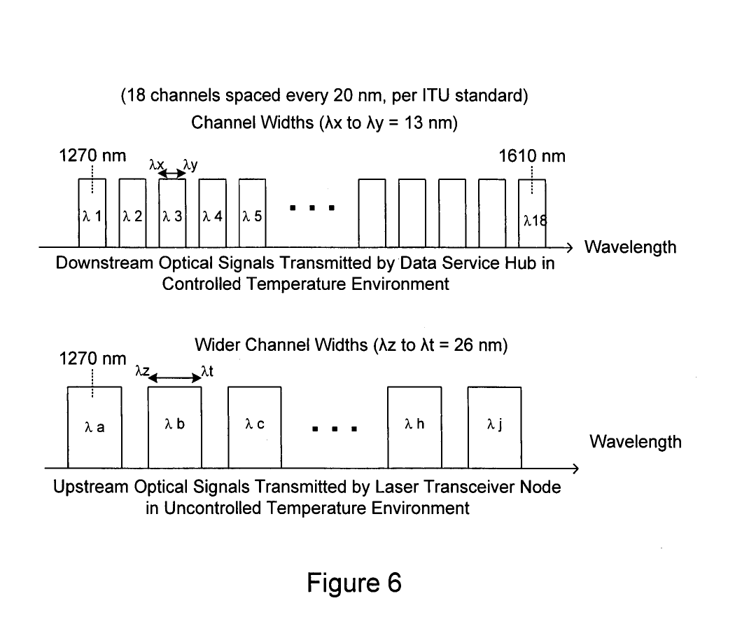

FIG. 6 illustrates a wavelength allocation plan according to an exemplary embodiment of the inventive system 300. As explained earlier, the data service hub 310 is commonly temperature-controlled. Because of this, laser signals transmitted by the optical transmitters 425 therein do not have a problem adhering to the ITU standard wavelength widths. On the other hand, a laser transceiver node 320 is often located in sources where extreme temperatures are possible. Thus, conventional techniques utilizing the ITU standard are not conducive for the proper transmission of signals from an optical waveguide transceiver 530 located in a laser transceiver node 320 exposed to extreme temperatures. As discussed, this is because a signal transmitted from an optical waveguide transceiver 530 in a laser transceiver node 320 may “drift” from its center wavelength beyond the 13 nm channel width that is accorded to each channel in the ITU standard. FIG. 2 illustrates the drift.

To solve this problem, the inventive system 300 allocates wavelengths in such a way as to accommodate the wavelength drift associated with extreme temperatures. The graph located in the top portion of FIG. 6 illustrates a wavelength allocation for downstream data originating from the data service hub 310. According to this exemplary embodiment, the wavelength allocation for this downstream data corresponds to the standard ITU wavelength channel allocation. As stated, this is because the data service hub 310 is temperature controlled and, therefore, waveguides located therein do not experience excessive wavelength drifts and thus can adhere to the ITU standard wavelength widths.

In contrast to the temperature controlled data service hub 310, a laser transceiver node 320 exposed to extreme temperatures may have a variation in wavelength of more than 16 nm. Under these conditions, an optical waveguide transceiver 530 disposed in the laser transceiver node 320 would be unable to adhere to the ITU wavelength allocation. Therefore, the graph in the bottom portion of FIG. 6 illustrates a wavelength allocation that allows for transmission in these extreme temperatures. As is illustrated, the upstream channel width, i.e., the channel width for signals originating from the laser transceiver node 320, are wider than the corresponding downstream channel widths transmitted from the data service hub 310. Specifically, the downstream channel widths in this exemplary allocation are roughly twice the width of the standard ITU channels. In this way, the upstream channel is wide enough to accommodate the excessive drift of the optical transmitter 425 in the optical waveguide transceiver 530. Thus, the closer-spaced channels illustrated in the top portion of FIG. 6 may be used for downstream transmission from the temperature controlled data service hub 310, while the wider channels illustrated in the bottom portion of FIG. 6 may be used for upstream transmission from the uncontrolled laser transceiver node 320.

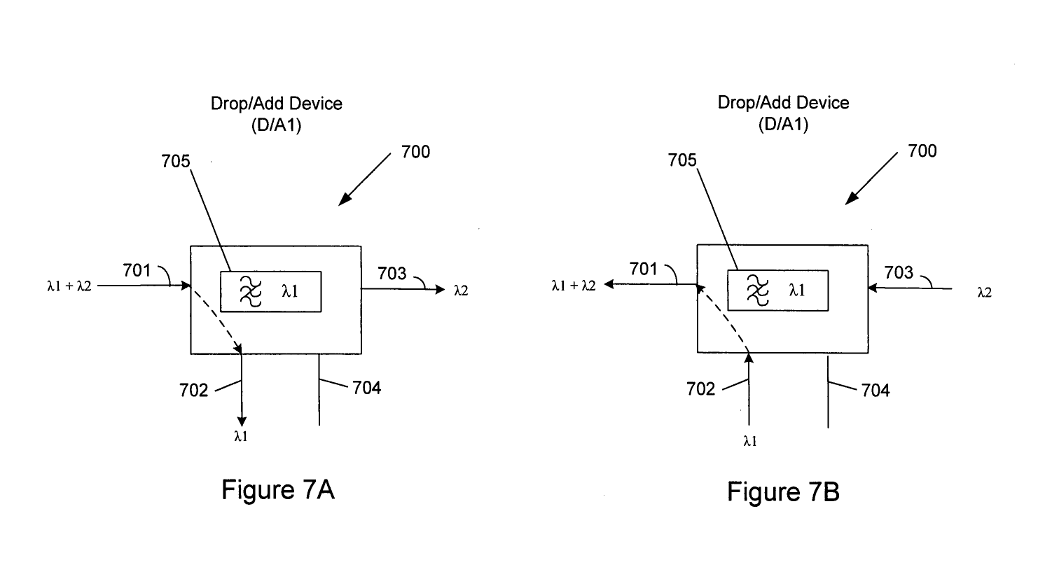

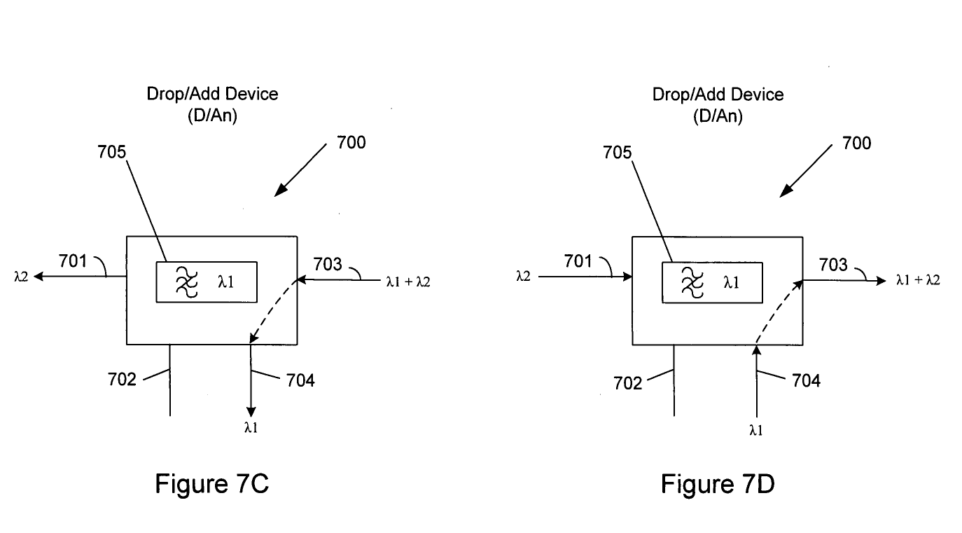

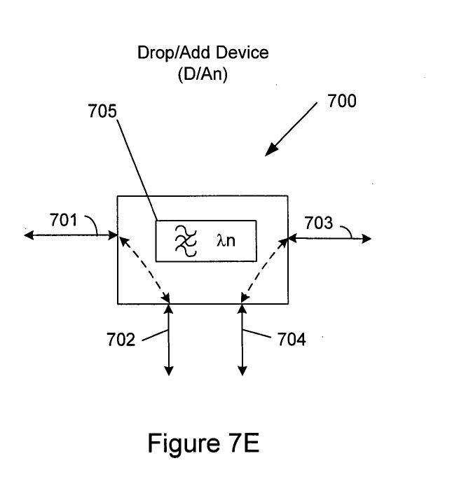

In order to implement the exemplary wavelength channel allocations illustrated in FIG. 6, the inventive system 300 may comprise a Drop/Add (D/A) device and multiplexer/demultiplexer (MUX/DMUX). Such devices are commercially available and are understood by those skilled in the art. Additionally, FIGS. 7A-E and 8A-C exemplify typical configurations of a Drop/Add device 700 and MUX/DMUX 800 that may be utilized to implement the exemplary embodiments of the inventive system 300 disclosed herein.

FIGS. 7A-E illustrate an optical D/A device 700 that may be used to implement exemplary embodiments of the inventive system 300. It is noted that this device should not to be confused with a Drop/Add multiplexer, although it performs an analogous function in the optical domain. As is known by one of ordinary skill in the art, a D/A device 700 is a passive optical device that may comprise a left port 701, a right port 703, a bottom left port 702, a bottom right port 704, and a band stop filter 705 in which wavelengths are specified to be “dropped” or “added.” Optical signals may enter the D/A device 700 at the left or right port 701, 703. The D/A device 700 then “drops,” or routes, a signal from the other signals to the bottom left or bottom right ports 702, 703, according to the wavelength specified by the band stop filter 705.

As examples of the above, FIG. 7A illustrates wavelengths centered at λ1 and λ2 entering the left port 701. The band stop filter in FIG. 7A is tuned to wavelength λ1 and has a certain channel width allocation. Therefore, a signal within the channel width allocation corresponding to the centered wavelength λ1 will “drop” from the device 700 out of the bottom left port 702. The remaining signal, λ2, however, continues through the device 700 and exits through the right port 703. Thus, all of the optical signals entering at the left port 701, except for a signal within the channel allocation of the band stop filter 705, will pass through the device and out of the right port 703 unaffected (except for a small amount of attenuation). Any signal within the specific wavelength channel allocation specified by the band stop filter 705, however, will be routed, or “dropped,” to the bottom left port 702.

The device is also symmetrical, such that a signal within the design of the band stop filter 705 may enter the bottom left port 702 and propagate to the left port 701, where it is combined or summed with optical signals at other wavelengths that enter the right port 703 and pass through the device to the left port 701. Thus, as is illustrated in FIG. 7B, optical signal λ2 may enter the right port 703, while λ1 enters the bottom left port 702. The D/A device 700 then “adds” the signals together and they exit together at the left port 701.

Similarly, FIGS. 7C-D provide examples of how a signal is added or dropped between the left port 703 and the bottom right port 704. As is illustrated in FIG. 7C, all wavelengths, except the wavelength falling within the channel allocation centered at wavelength λ1, will pass through to the left port 701. However, a signal within the channel width centered at λ1 will be diverted to the bottom right port 704. In the reverse, as is illustrated in FIG. 7D, a signal at wavelength λ1 may enter at the bottom right port 704 and propagate to the right port 703, where it is combined or summed with optical signals at other wavelengths which enter at the left port 701 and pass through the device to the right port 703.

FIG. 7E exemplifies a D/A device 700 that may be used on an optical waveguide 370 ring, as will be discussed in further detail below. The left port 701 and right port 703 may be connected to a waveguide 370 (not illustrated in FIG. 7E) and the bottom left port 702 and bottom right port 704 may be connected to a laser transceiver node (not illustrated in FIG. 7E). In this exemplary embodiment, a multiplicity of signals transmitted by a data service hub 310 (not illustrated in FIG. 7E) may be propagated downstream via an optical waveguide 370. These signals would enter the D/A device 700 via the left or right ports 701, 703 and a signal corresponding to the band stop filter 705 design would exit the bottom left or bottom right ports 702, 704, respectively. In the upstream, a laser transceiver node 320 would transmit a signal into the bottom left or bottom right port 702, 704 and the signal would be “added” to the other signals being transmitted through the device 700 from the right or left port 701, 703.

In implementing the exemplary embodiments disclosed herein, a different D/A device 700 may be designed for every wavelength λn and channel width allocation. For example, a laser transceiver node 320 may be designed to receive a wavelength from the data service hub 310 centered at 1270 nm. To accomplish this, a D/A device 700 with a channel allocation centered at 1270 nm and a channel width of 13 nm (i.e., the ITU standard width) may be designed to “drop” the signal to the laser transceiver node 320. Likewise, according to an exemplary embodiment of the inventive system 300, another D/A device 700 designed with a band stop filter specified at 1270 nm and a channel width of 26 nm may be utilized to “add” the upstream signal transmitted by the laser transceiver node 320 with other wavelengths. These signals are then sent to the data service hub 310 on one upstream waveguide 380. In this same manner, other D/A devices 700 may be designed to drop or add signals for laser transceiver nodes 320. Further, additional features and implementations of the D/A device 700 will become apparent to one of ordinary skill in the art in reference to the figures and specification illustrating the various exemplary embodiments disclosed herein.

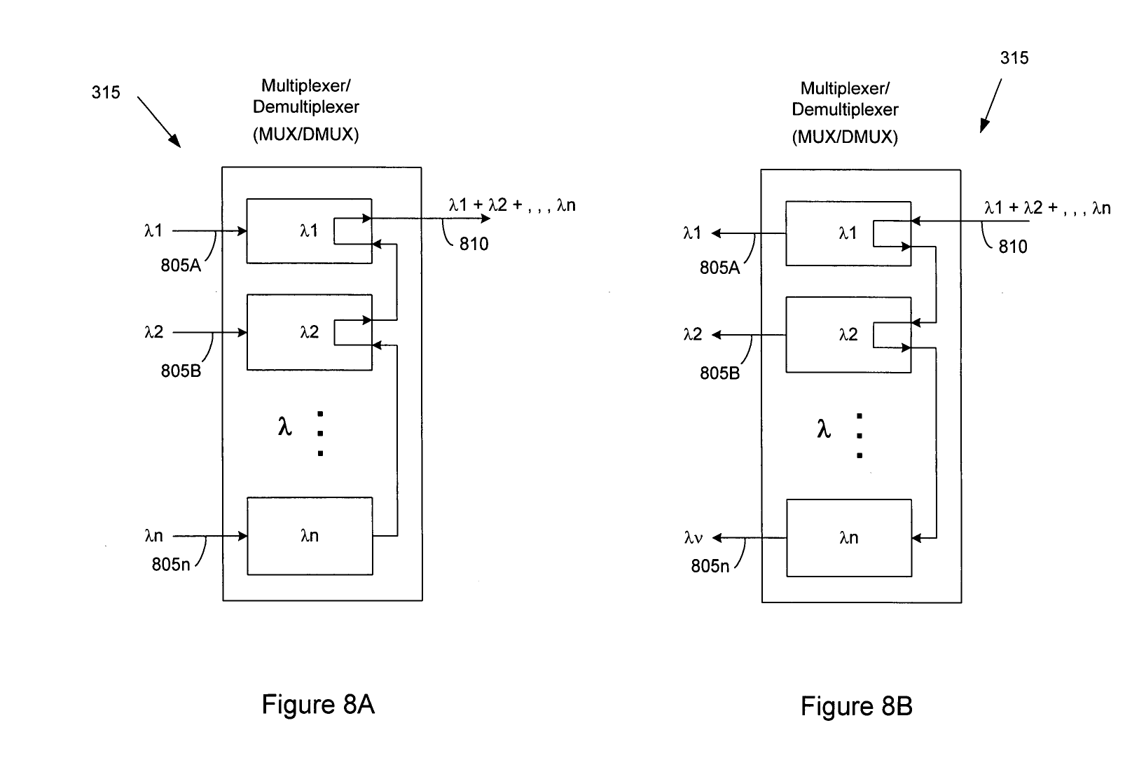

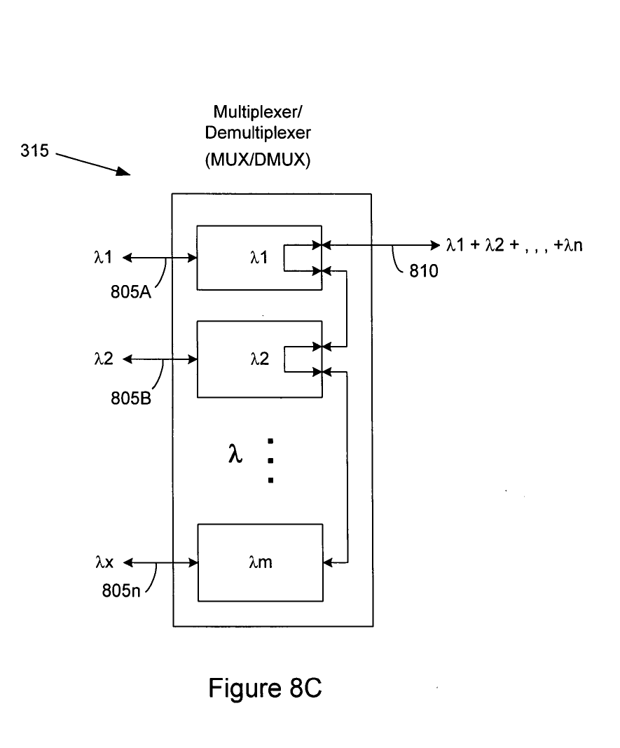

FIGS. 8A-C illustrate a similar device to the D/A device 700 called a coarse wave division multiplexer/demultiplexer (MUX/DMUX) 315, also often referred to by the terms CWDM MUX or DMUX. This device is known to one of ordinary skill in the art and may be used as a multiplexer to combine signals, or as a demultiplexer to separate signals. The MUX/DMUX 315 is used as a multiplexer to combine optical signals at different wavelengths. For example, wavelengths λ1, λ2, λ3 . . . λn may be combined into one optical signal.

As is illustrated in FIG. 8A, when used as a multiplexer, individual signals, such as wavelengths λ1, λ2, and λ3, enter at the appropriate ports 805A-n on the left and a composite of all signals, λ1+λ2+λ3, exits at the input/output port 810 on the top right. Similarly, as is illustrated in FIG. 8B, when the MUX/DMUX 315 is used as a demultiplexer, a composite of all signals enters at the input/output port 810, and individual signals at predetermined wavelengths exit at the ports 805A-n on the left. Further, the MUX/DMUX 315 may operate simultaneously as a multiplexer at some wavelengths and as a demultiplexer at others. This is illustrated in FIG. 8C. Additionally, as is known by one of ordinary skill in the art, the MUX/DMUX may be optimized for minimum insertion loss when multiplexing and may be designed for the required adjacent channel rejection when demultiplexing.

Like the D/A device 700, a MUX/DMUX 315 may be designed to multiplex or demultiplex according to a certain wavelength and associated channel width. For example, a MUX/DMUX 315 may be designed to multiplex and demultiplex signals centered at 1270 nm, 1290 nm, 1320 nm, and 1350 nm that fall within a 13 nm channel width (i.e., the ITU standard width). In this case, wavelengths falling within 6.5 nm of the center wavelength (e.g., 1263.5 to 1276.5 nm for the 1270 nm channel) would be multiplexed or demultiplexed according to this design. Likewise, a MUX/DMUX 315 may be designed with the above center channel widths, but with wider channel width allocations. For example, the MUX/DMUX 315 may be designed according to channel widths twice that of the ITU standard, or 26 nm. Designed in this way, wavelengths entering within plus or minus 13 nm of the center wavelength would be multiplexed or demultiplexed.

Additionally, one MUX/DMUX 315 may be designed to multiplex and demultiplex signals according to various channel widths. For example, some wavelengths may be multiplexed and demultiplexed according to a channel width allocation of 13 nm, whereas other signals may be multiplexed or demultiplexed based on a channel width allocation of 26 nm. Thus, the MUX/DMUX 315 may be designed in order to implement the various exemplary embodiments disclosed herein. Consequently, one of ordinary skill in the art will appreciate the various functions and implementations of the MUX/DMUX 315 that will become apparent from the specification and associated figures below.

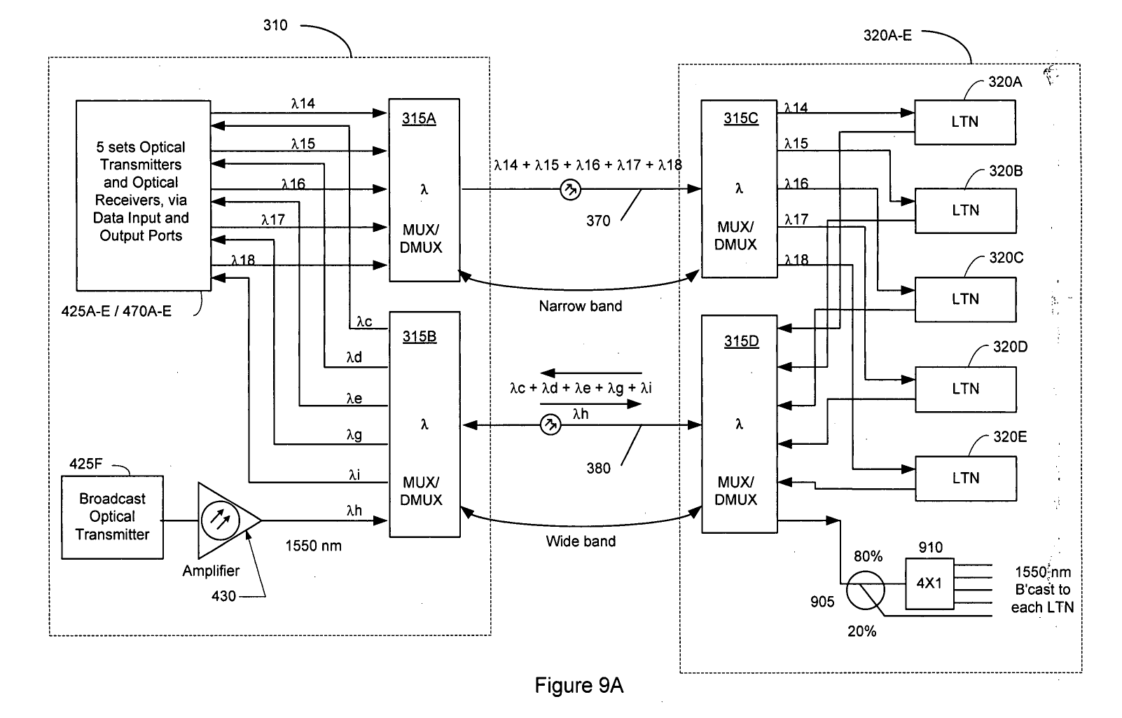

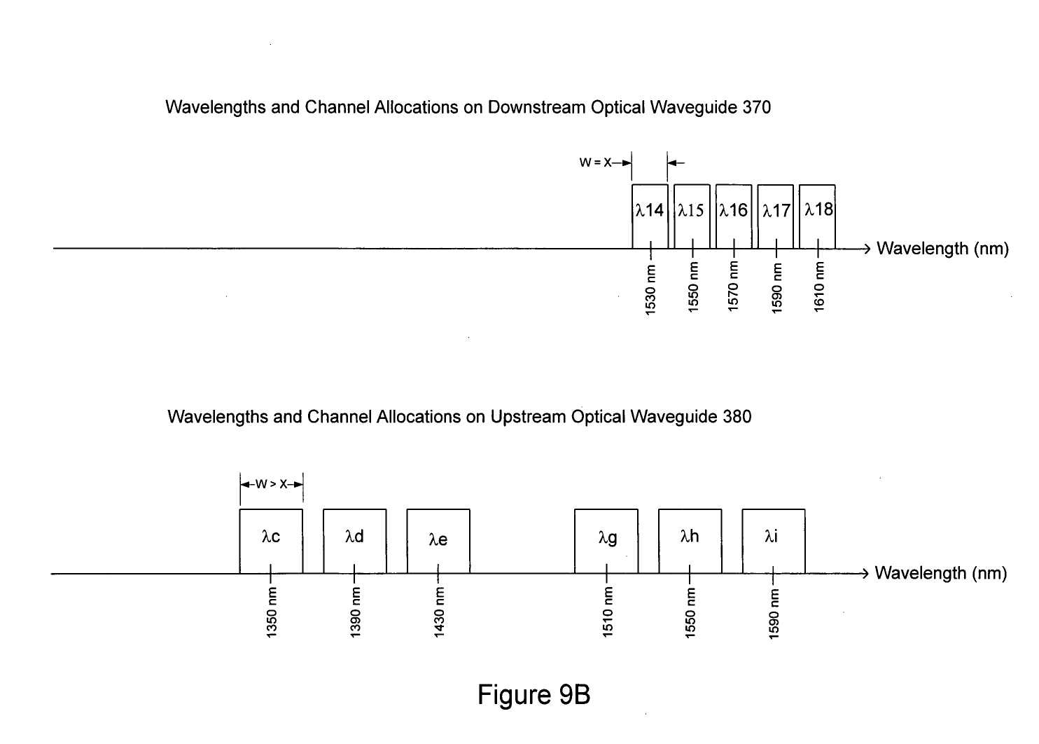

Utilizing the above A/D device 700 and MUX/DMUX 315, exemplary embodiments of the present inventive system 300 may be illustrated. In the following exemplary embodiments illustrated in FIGS. 9-13, wavelengths identified by numbers (e.g., λ1, λ2, λ3, etc.) are downstream wavelengths and are illustrated as having a first wavelength channel allocation of X width, where X represents a width (W) in nanometers. For example, in FIG. 6, the numbered wavelengths are illustrated as having a wavelength centered at a certain wavelength, e.g., 1270 nm, and having a channel allocation according to the ITU standard, i.e., a channel width of 13 nm. Therefore, in FIG. 6, X is equal to 13 nm. Given this channel allocation, a MUX/DMUX 315 would multiplex or demultiplex as the 1270 nm wavelength any signal sent to it ranging from 1263.5 nm to 1276.5 nm. Likewise, in FIGS. 9-13, a MUX/DMUX 315 would multiplex or demultiplex any signal as a specified wavelength if it fell within the plus or minus one-half of X of the specified wavelength.

Different from downstream wavelengths, upstream wavelengths are identified in the exemplary embodiments disclosed herein by letters (e.g., λa, λb, λc, etc.), and are specified as having a second wavelength channel allocation in which wider channels are utilized. For example, a wavelength centered at 1270 nm in the bottom portion of FIG. 6 is illustrated as having a channel width (W) that is wider than the channel widths of the first wavelength channel allocation. Therefore, in FIG. 6, any channel widths greater than the ITU standard, i.e., greater than 13 nm, could be utilized in the upstream direction. As illustrated in FIG. 6, the upstream channel widths can be twice the width of channel widths in the ITU standard, or 26 nm. Given this channel allocation, a MUX/DMUX 315 multiplexing and demultiplexing downstream wavelengths would multiplex or demultiplex any signal sent to it ranging from 1257 nm to 1283 nm as being the 1270 nm wavelength.

In FIGS. 9-13, the wider channel widths are illustrated as being greater than the width specified for the downstream channel widths. As stated, the downstream channel widths are represented as having a width of X in FIGS. 9-13. Therefore, the wider upstream wavelength channel widths are represented in FIGS. 9-13 as having a width (W) that is greater than X, i.e., W>X. Thus, these figures specify that the downstream channel widths are of any width greater than X. It should also be noted that the exact wavelength used as the center of each optical signal in the exemplary embodiments illustrated in FIGS. 9-13 is not important and should, therefore, not be construed as a limitation of the inventive system 300. That is, although a frequency of 1270 nm may be a representative wavelength in a particular wavelength channel allocation figure, it is the graphical illustration of the channel width surrounding that particular wavelength that is important, not the wavelength itself.

FIG. 9A illustrates an exemplary embodiment of the inventive system 300 where multiple laser transceiver nodes 320 are located in close proximity to one another. Accordingly, this embodiment may be utilized at times when it is desirable to co-locate a number of laser transceiver nodes 320. For example, if a system operator has a subdivision of only a few hundred homes, he or she may want to extend a single pair of optical waveguides to the entry of the subdivision and co-locate five laser transceiver nodes 320 at that point to serve all of the subscribers in the subdivision. Thus, this configuration may be achieved by utilizing the asymmetrical optical exemplary embodiments illustrated in FIGS. 9A-B.

According to this exemplary embodiment, a set of five optical transmitters 425A-E and optical receivers 470A-E may be located at the data service hub 310 in a controlled temperature environment. As is illustrated, these optical transmitters 425A-E and optical receivers 470A-E correspond to five laser transceiver nodes 320A-E, illustrated on the right of FIG. 9A. While five laser transceiver nodes 320A-E are illustrated, this number is for exemplary purposes only and should not be considered as a limitation of this particular exemplary embodiment.

To facilitate the transmission of the optical signals, the inventive system 300 also comprises four MUX/DMUX 315A-D, a downstream optical waveguide 370, and an upstream optical waveguide 380. While a line is drawn around the laser transceiver nodes 320A-E and the MUX/DMUX 315C, 315D in FIG. 9A, this is for illustration only. One of ordinary skill in the art knows that the MUX/DMUX 315C, 315D may or may not also be co-located with the laser transceiver nodes 320A-E. The output of each optical transmitter 425A-E is routed to a MUX/DMUX 315A with five input ports and one output port. The optical signals exiting the MUX/DMUX 31 SA are multiplexed, or summed together, and carried downstream by the downstream optical waveguide 370 to the location of the laser transceiver nodes 320A-E. The individual optical signals are then de-multiplexed, or separated, in another MUX/DMUX 315C and transferred to each corresponding laser transceiver nodes 320A-E.

The upstream optical signals λc through λi, excluding λh, are generated by five optical waveguide transceivers 530 (not illustrated in FIG. 9A), respectively residing in each laser transceiver node 320. They are combined into one optical waveguide by a MUX/DMUX 315D and sent upstream on the upstream optical waveguide 380. At the data service hub 310, the wavelengths are again separated in a MUX/DMUX 315B and then sent to optical receivers 470A-E (not illustrated in FIG. 9A) located in the data service hub 310.

FIG. 9B illustrates a wavelength allocation plan according to an exemplary embodiment of the inventive system 300. The top portion is a graphical illustration of the wavelength channel widths for the downstream data that is communicated on downstream optical waveguide 370. Because the optical transmitters 425 which generate the optical signals from the data service hub 310 are located in a temperature controlled environment, conventional wavelength spacing may be used, as is illustrated, for the downstream wavelength allocation. Thus, the downstream wavelength channel widths may correspond to the ITU standards. It should also be noted that the specific wavelengths illustrated in FIG. 9B (e.g., 1530, 1550, etc.) are exemplary and should not be considered as limitations. Accordingly, any five wavelengths may be used according to an exemplary embodiment of the inventive system as illustrated in FIG. 9B.

The wavelength channel width used in the upstream direction for the exemplary embodiment is illustrated in the bottom portion of FIG. 9B. Again, the particular wavelengths illustrated should not be construed as a limitation of the inventive system 300. As is illustrated, these wavelength band widths are wider than those in the downstream direction. These wider bands account for the wavelength drift that may be associated with the laser transceiver nodes 320A-D and are approximately twice the size of the ITU standard bandwidths. Thus, according to an exemplary embodiment of the inventive system 300 illustrated in FIG. 9, the downstream wavelengths transmitted from the data service hub 310 comprise wavelength channel widths comparable to the ITU standard, while the upstream wavelengths transmitted from the laser transceiver nodes 320A-E comprise wavelength channel widths that are wider than the ITU standard.

An unexpected feature of the inventive system 300 is the availability for the inclusion of a downstream broadcast optical signal λh on the upstream waveguide 380. As illustrated in FIG. 9A, a broadcast optical transmitter 425F generates a broadcast optical signal at a wavelength of 1550 nm. This signal is then amplified in an amplifier 430 and supplied as an input to one of the six ports located on the MUX/DMUX 315B. Because the MUX/DMUX 315B is a bidirectional device, it works in both directions simultaneously. Accordingly, the MUX/DMUX 315B combines the downstream broadcast optical signal at 1550 nm with the upstream data signals originating from the laser transceiver nodes 320A-E.

At the MUX/DMUX 315D, the broadcast optical signal is separated from the upstream data signals. It is then routed to a coupler 905 which extracts approximately 20% of the signal power to go to one of the laser transceiver nodes 320A. The remaining signal power is split four ways in a splitter 910 and supplied to the other four laser transceiver nodes 320B-E. If necessary, another optical amplifier 430 can also be placed on the end of this link to amplify the signal for broadcast to the laser transceiver nodes 320B-E.

The combination of the downstream video with the upstream data avoids problems associated with transmitting data and video in the same direction. Those skilled in the art know that if the data signals carried on λc through λi were flowing in the same direction as the broadcast video on λh, interference would likely develop due to a well-known phenomenon known as stimulated Raman scattering (SRS). To prevent this, conventional methods call for the video signal to be carried on a separate optical waveguide. However, since the broadcast signal flows in the opposite direction of the upstream data signals in FIG. 9, SRS interference does not develop. Therefore, the present invention offers a novel and unconventional approach by propagating a broadcast signal downstream where upstream data is being propagated on the same optical waveguide 380. Thus, this approach reduces the need for broadcasting the video signal on a separate optical waveguide in order to prevent SRS.

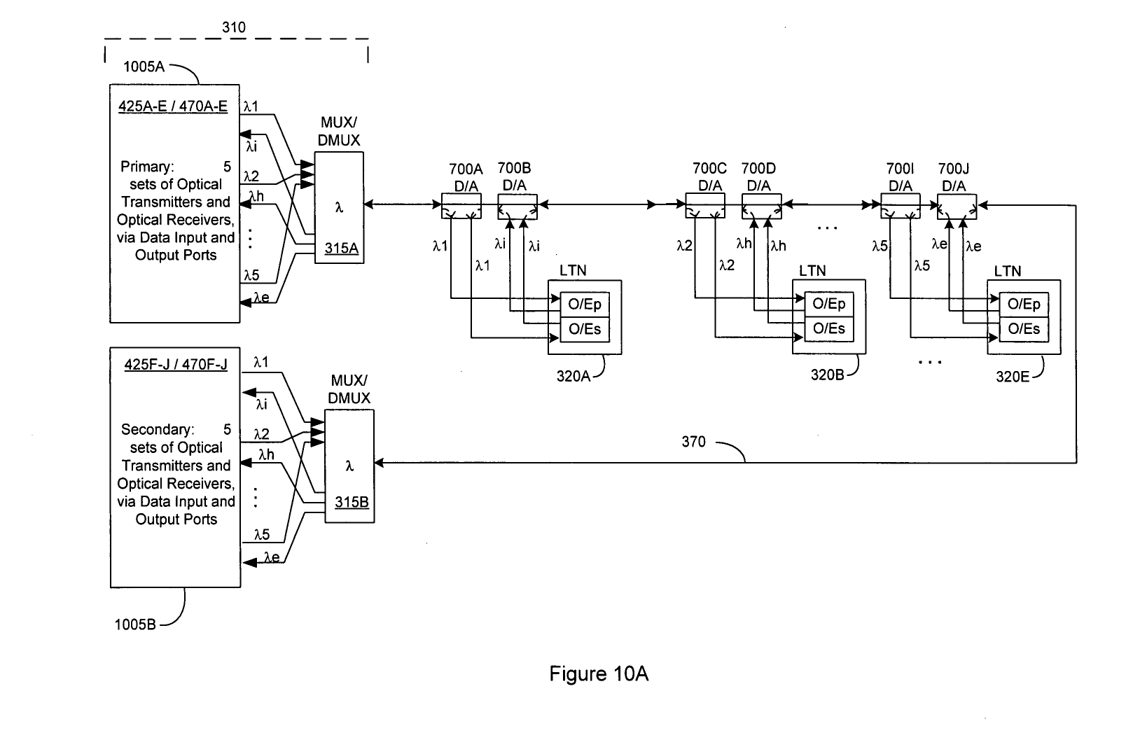

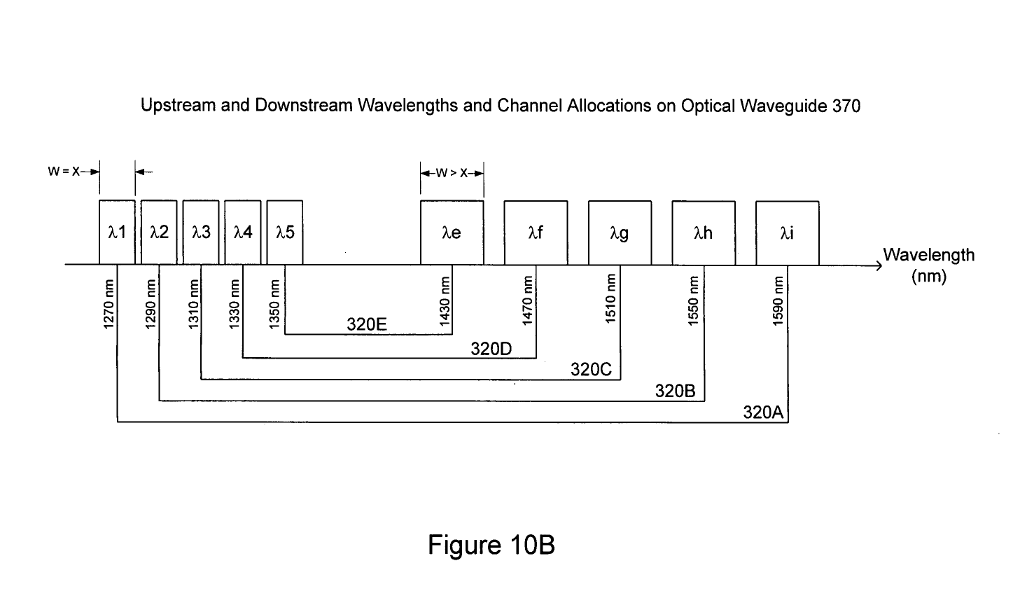

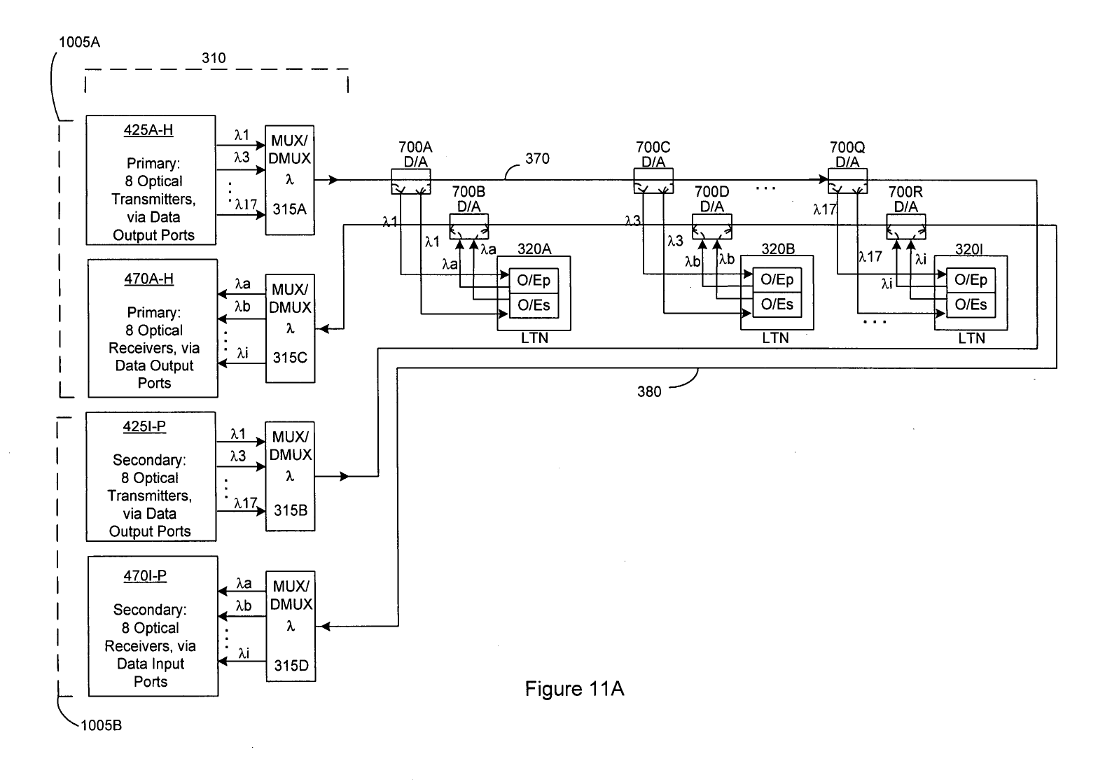

FIG. 10A illustrates another exemplary embodiment of the inventive system 300. In this embodiment, five laser transceiver nodes 320A-E may be connected to a data service hub 310 using a single optical waveguide 370 that forms a ring connecting the data service hub 310 and all laser transceiver nodes 320A-E. The laser transceiver nodes 320A-E may be, but are not necessarily, co-located. The optical waveguide 370 ring provides for route redundancy, as is understood by one of ordinary skill in the art. Thus, if the optical waveguide is broken at any point around the ring, there remains a path back to the data service hub 310 so that communications may continue while the break is repaired. Further, when the optical waveguide 370 is not broken, twice the bandwidth may be used between the data service hub 310 and each laser transceiver node 320A-E.

As illustrated in FIG. 10A, the data service hub 310 further comprises a first set of data ports 1005A and a second set of data ports 1005B. These data ports may comprise data output ports 460 and data input ports 465 (as illustrated in FIG. 4), or the data ports may be dual input/output ports. In any event, the first set of data ports 1005 comprises a multiplicity of optical transmitters 425A-E and optical receivers 470A-E. These optical transmitters 425A-E and optical receivers 470A-E are utilized when there is no break in the optical waveguide 370. The second set of data ports 1005B comprises a set of secondary optical transmitters 425F-J and optical receivers 470F-J. These optical transmitters 425F-J and receivers 470F-J may be utilized if there is a break somewhere in the ring, in order to provide redundancy for the inventive system 300.

Note that, besides providing redundancy, the first and second sets of data ports 1005A-B may also be used simultaneously to provide for higher bandwidth to each laser transceiver node 320A-E when the optical waveguide 370 forms a functional ring. In this configuration, if the ring formed by optical waveguide 370 were to be broken, the total bandwidth to each laser transceiver node 320A-E would be reduced; however, communication would still be possible while the break was repaired because of the route redundancy of the system.

Two MUX/DMUX 315A-B also comprise the exemplary embodiment illustrated in FIG. 10A. As is illustrated, the MUX/DMUX 315A-B are utilized both for multiplexing and demultiplexing simultaneously. Thus, each MUX/DMUX 315-B multiplexes, or combines, the downstream optical signals on wavelengths λ1 through λ5, and demultiplexes, or separates, the upstream optical signals on wavelengths λe through λi simultaneously. As is known in the art, this is possible because the MUX/DMUX 315 operates identically in both directions.

In addition to the two MUX/DMUX 315A-B, the inventive system 300 also comprises multiple D/A devices 700A-F. As in FIG. 9, the numbered wavelengths carry information downstream from the data service hub 310 to the various laser transceiver nodes 320A-E, while the lettered wavelengths carry information upstream from the various laser transceiver nodes 320A-E to the Data service hub 310.

FIG. 10B illustrates a corresponding exemplary wavelength allocation plan for the exemplary embodiment of FIG. 10A. Note that the downstream and upstream wavelengths are paired. For example, λ1 is downstream and λi is the corresponding upstream wavelength for the first laser transceiver node 320A. Similarly, λ2 and λb serve the second illustrated laser transceiver node 320B. This continues through to the last illustrated laser transceiver node 320E. The wavelength allocation plan illustrated in FIG. 10B is, of course, for exemplary purposes only and is not meant to limit the potential configurations of the inventive system 300. There are an unlimited number of ways to combine the upstream and downstream wavelengths, so long as the upstream wavelength bands are broader than the downstream wavelengths in order to accommodate the wavelength drift of the lasers in the laser transceiver nodes 320A-E.

To operate the system 300 according to the wavelength allocations defined in FIG. 10B, the MUX/DEMUX 315A-B and D/A device 700A-E must be designed to according to the wavelength allocation plan. Specifically, the MUX/DMUX 315A-B would be designed according to the ITU standard for the data transmitted in the downstream direction by the data service hub 310, while the MUX/DMUX 315A-B would be designed according to wavelength channels approximately twice the ITU standard for data transmitted upstream from the laser transceiver node 320. Further, according to an exemplary embodiment, the lettered D/A devices 700B, 700D, 700F must be specified to a wide bandwidth such that they may accommodate the wavelength drift of the lasers transmitted by the laser transceiver nodes 320. Likewise, the numbered D/A devices 700A, 700C, 700E, must be designed for narrow bandwidths to accommodate the normal ITU wavelength allocations utilized by the lasers in the data service hub 310. Therefore, according to this exemplary embodiment, the wavelength channels of the wavelength-lettered D/A devices 700B, 700D, 700F may be twice the width of the wavelength-numbered D/A devices 700A, 700C, 700E. Further, the wavelength-numbered D/A devices 700A, 700C, 700E, may have a bandwidth allocation according to that defined by the ITU standard.

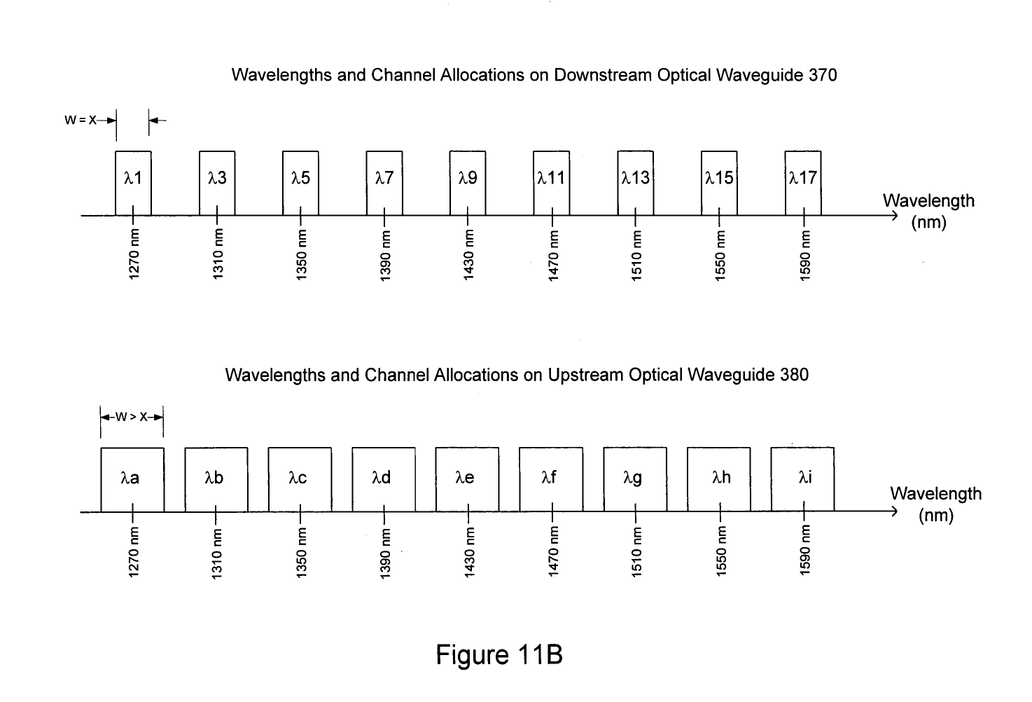

FIG. 11 A is yet another exemplary embodiment of the inventive system 300 comprising nine laser transceiver nodes 320A-I utilizing two optical waveguides 370, 380. As in FIG. 10A, FIG. 11A also provides redundancy by utilizing a first and secondary data port 1005A-B. The first data port 1005 comprises data output ports 325A-H and data input ports 370A-H. The second data port 1005 comprises data output ports 325I-P and data input ports 370I-P. Further, according to an exemplary embodiment, two MUX/DMUX 315A-B are utilized for the downstream channel, while two MUX/DMUX 315C-D are utilized for the upstream channel.

In addition to the two MUX/DMUX 315A-D, the inventive system 300 illustrated in FIG. 11A also comprises multiple D/A devices 700A-R. As before, the numbered wavelengths carry information downstream from the data service hub 310 to the various laser transceiver nodes 320A-I, while the lettered wavelengths carry information upstream from the various laser transceiver nodes 320A-I to the data service hub 310.

FIG. 11B illustrates an exemplary wavelength plan for the exemplary embodiment illustrated in FIG. 11A. According to this exemplary embodiment, every other ITU wavelength is used in the downstream direction, thereby allowing for nine laser transceiver nodes 320A-I to be utilized without exceeding the ITLJ bandwidth allocations. While it is possible to use other sets of wavelengths, preferred exemplary embodiments would all use defined ITU wavelengths in the downstream direction. Note that it is also possible to utilize more ITU channel allocations for downstream wavelengths if it is important to deliver more downstream than upstream bandwidth. This so-called asymmetrical bandwidth allocation is used in some standard systems.

In the upstream direction, wider channel widths are utilized to accommodate the wavelength drift associated with the effect of extreme temperatures on the laser transceiver nodes 320A-I. As illustrated in FIG. 11B, like wavelengths are used for the downstream and upstream communications to and from each laser transceiver node 320A-I. That is, for laser transceiver node 320A, the downstream wavelength λ1 and the upstream wavelength λa are both centered at a wavelength of 1270 nm. This correspondence, however, is only for exemplary purposes; accordingly, one of ordinary skill in the art is aware that other variations could be utilized without departing from the scope and spirit of the present invention.

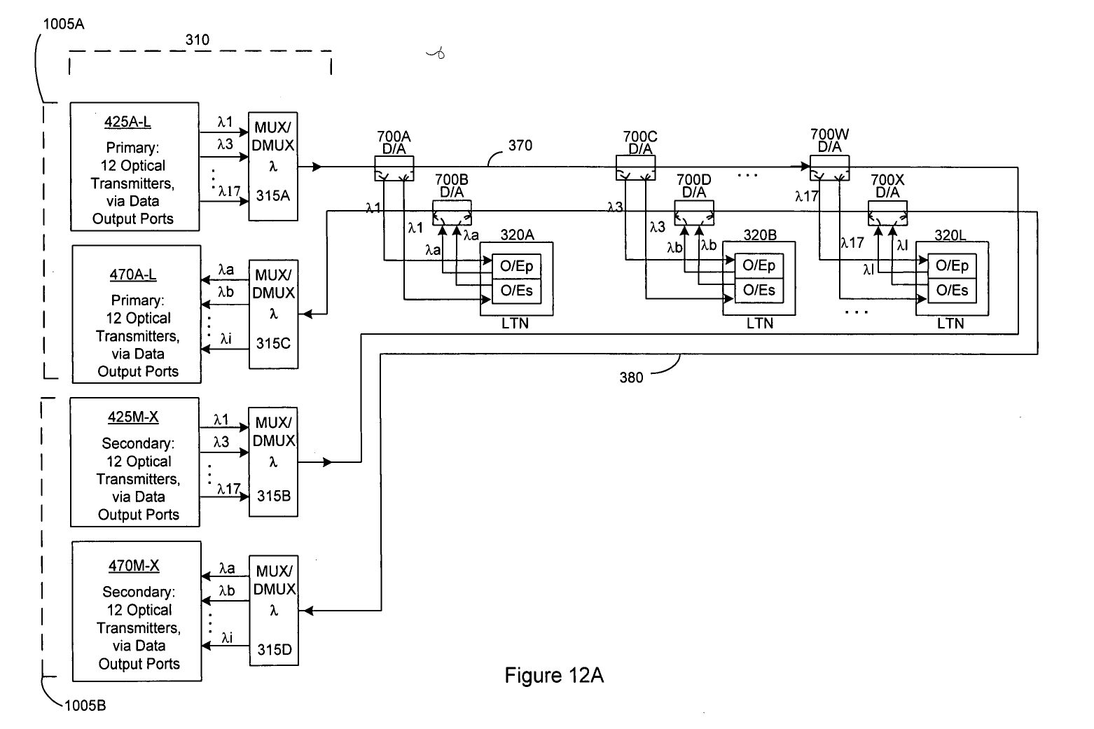

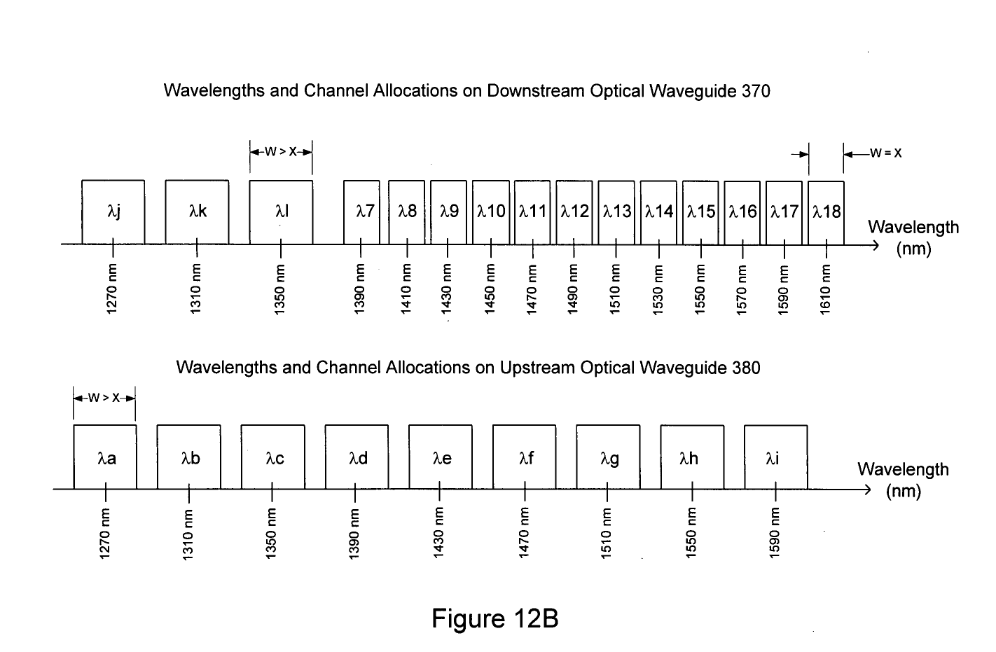

FIG. 12A illustrates yet another exemplary embodiment of the inventive system 300. As is illustrated in FIG. 12A, the inventive system comprises 12 laser transceiver nodes 320A-L utilizing two optical waveguides 370, 380. As in the two previous exemplary embodiments, FIG. 12A also provides redundancy by utilizing a first and secondary data port 1005A-B. The first data port 1005 comprises data output ports 325A-L and data input ports 370A-L. The second data port 1005 comprises data output ports 325M-X and data input ports 370M-X. Further, according to an exemplary embodiment, the inventive system 300 comprises four MUX/DMUX 315A-D. The MUX/DMUX 315A-B connected to the downstream optical waveguide 370 are designed to accommodate up to 15 wavelengths, where 12 of the wavelengths are used for downstream communications, and three are used for upstream communications. The two MUX/DMUX 315C-D connected to the upstream optical waveguide 380 are designed to accommodate the nine wavelengths.

Further, the inventive system 300 illustrated in FIG. 12A also comprises multiple D/A devices 700A-X. As before, the numbered wavelengths carry information downstream from the data service hub 310 to the various laser transceiver nodes 320A-L, while the lettered wavelengths carry information upstream from the various laser transceiver nodes 320A-L to the data service hub 310.

The above configuration may be better understood in reference to the wavelength channel allocation plan illustrated in FIG. 12B. Wavelengths λa through λ1 originate from the laser transceiver nodes 320A-L and, therefore, comprise wide wavelength bands to accommodate the wavelength drift associated with extreme temperatures at the laser transceiver nodes 320A-L. Additionally, it can be seen from FIG. 12B that wavelengths λj through λ1 are on the downstream optical waveguide 370, while wavelengths λa through λi are on the upstream optical waveguide 380. Thus, signals λj through λl run in the opposite direction as signals λ7 through λ18 on the downstream optical waveguide 370. This allows an increase in the number of laser transceiver nodes 320 that may be utilized by the inventive system 300.

FIG. 12B is similar to FIG. 11B except that the downstream wavelengths are “bunched” together at one edge of the ITU wavelength spectrum in FIG. 12B. This provides additional spectrum on the downstream optical waveguide 370 such that upstream data from three additional laser transceiver nodes 320J-L may be placed on the downstream optical waveguide 370. Accordingly, the advantage of utilizing this exemplary embodiment is that additional laser transceiver nodes 320 may be accommodated on the same optical ring (i.e., the optical network formed by the optical waveguides 370, 380).

Further, it is notable that in order to accommodate the wavelength channel allocation described in FIG. 12B, the MUX/DMUX 315A-B associated with the downstream data must be designed to multiplex and de-multiplex both wavelengths carried on both wide and narrow wavelength channels. Specifically, the downstream MUX/DEMUX 315A-B illustrated in FIG. 12A would be designed to have wide channel widths for wavelengths λj through λ1, while having narrow channel widths for λ7 through λ18. One of ordinary skill in the art will know how to construct such a device.

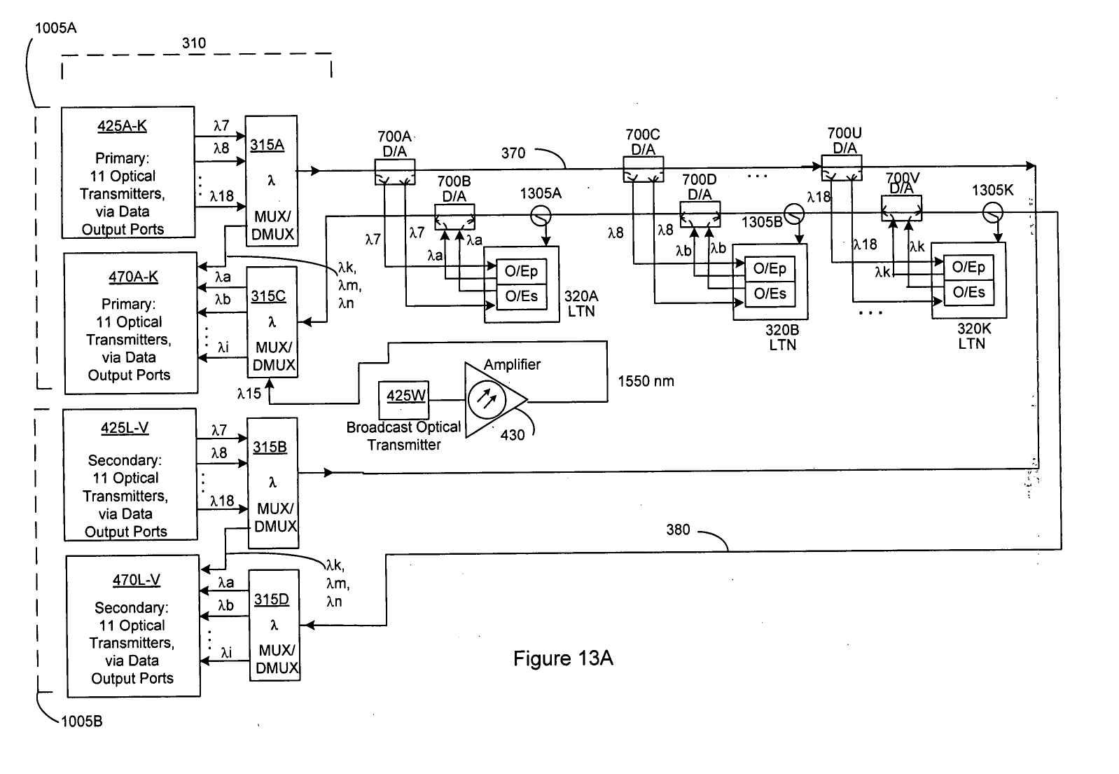

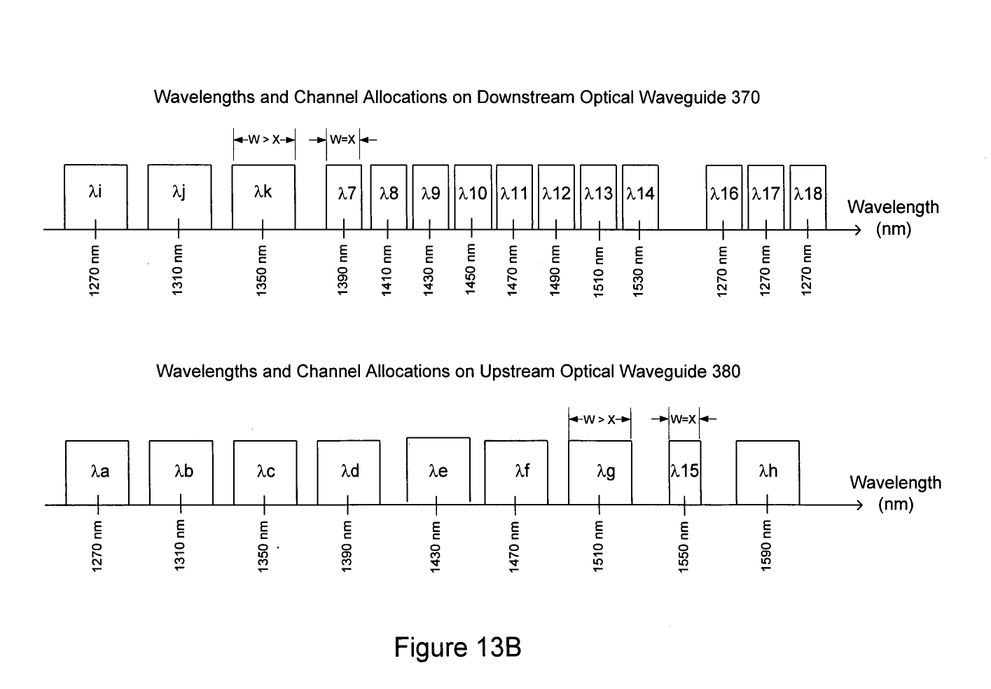

FIG. 13A illustrates yet another exemplary embodiment of the inventive system 300. The exemplary embodiment illustrated in FIG. 13A is very similar to the one illustrated in FIG. 12A, except that in FIG. 13A one of the upstream wavelengths has been altered to allow for broadcast video distribution downstream. Thus, the broadcast signal flows in the opposite direction from the data signals (i.e., flows downstream on the same waveguide as upstream data), thereby avoiding SRS interference.

Turning specifically to FIG. 13A, the inventive system 300 comprises eleven laser transceiver nodes 320A-K utilizing two optical waveguides 370, 380. As in the previous exemplary embodiments, FIG. 13 provides redundancy by utilizing a first and secondary data port 1005A-B. The first data port 1005 comprises data output ports 325A-H and data input ports 370A-H. The second data port 1005 comprises data output ports 3251-P and data input ports 3701-P.

The inventive system 300 illustrated in FIG. 13A further comprises four MUX/DMUX 315A-D. The MUX/DMUX 315A-B connected to the downstream optical waveguide 370 are designed to accommodate up to 14 wavelengths, where 11 are used for downstream communication from the data service hub 310 and three are used for upstream communication from the laser transceiver nodes 3201-K. In the upstream direction, the MUX/DMUX 315C-D connected to optical waveguide 380 are designed to accommodate up to nine wavelengths, where eight are utilized for upstream communication from the laser transceiver nodes 320A-H and one is used for downstream video distribution from the data service hub 310.

Further, the inventive system 300 illustrated in FIG. 13A also comprises multiple D/A devices 700A-V. As before, the numbered wavelengths carry information downstream from the data service hub 310 to the various laser transceiver nodes 320A-K, while the lettered wavelengths carry information upstream from the various laser transceiver nodes 320A-K to the data service hub 310.

The exemplary embodiment illustrated in FIG. 13A also offers the advantage of allowing an RF video signal to be broadcast to the laser transceiver nodes 320A-K. If utilized, an RF vide optical signal with a wavelength centered at 1550 nm originates from a broadcast optical transmitter 425 and is amplified by an amplifier 430 before being injected into the upstream optical waveguide 380. The video signal at 1550 nm propagates downstream in the reverse direction as the upstream data on the optical waveguide 380 and is received by each laser transceiver node 320A-K via a coupler 1305A-K.

The broadcast video signal may be injected at either upstream MUX/DMUX 315B, 315D, however, in FIG. 13A it is illustrated as being supplied to the MUX/DEMUX 315B attached to the first data ports 1005A. Additionally, the broadcast optical signal could likewise be injected into both MUX/DEMUX 315B, 315D to provide for redundancy. However, this configuration would require intelligent D/A devices 700 at all laser transceiver nodes 320A-K. One of ordinary skill in the art knows how intelligent D/A devices 700 may be designed and operated. Specifically, if enabled for redundancy, the intelligent D/A device 700A-V would block signal transmission at wavelength λ15 between ports 701 and 703 (as illustrated in FIG. 7), unless the D/A device 700A-V detected a signal missing in one direction or the other. In that case, it would couple signals at all wavelengths between ports 701 and 703.

The above configuration may be better understood in reference to the corresponding wavelength channel allocation plan illustrated in FIG. 13B. Wavelengths λa through λk originate from the laser transceiver nodes 320A-K and proceed upstream via optical waveguide 380. As is illustrated in FIG. 13B, these signals are utilized over wide wavelength bands to accommodate the wavelength drift associated with extreme temperatures that may occur at the laser transceiver nodes 320A-K. Also as illustrated in FIG. 13B, wavelengths λa through λh proceed to the data service hub 310 (not illustrated in FIG. 13B) over the upstream optical waveguide 380 while wavelengths λi through λk proceed upstream over the downstream optical waveguide 370. Additionally, wavelengths λ7 through λ14, as well as λ16 through λ18 are propagated along the downstream optical waveguide 370. The broadcast optical video signal, signified as wavelength λ15 in FIG. 13B, is propagated downstream along the upstream optical waveguide 380 so as to avoid the occurrence of Raman scattering. Thus, the exemplary embodiment offers significant advantages over the conventional technique of broadcasting the RF optical signal along an additional optical waveguide 360.

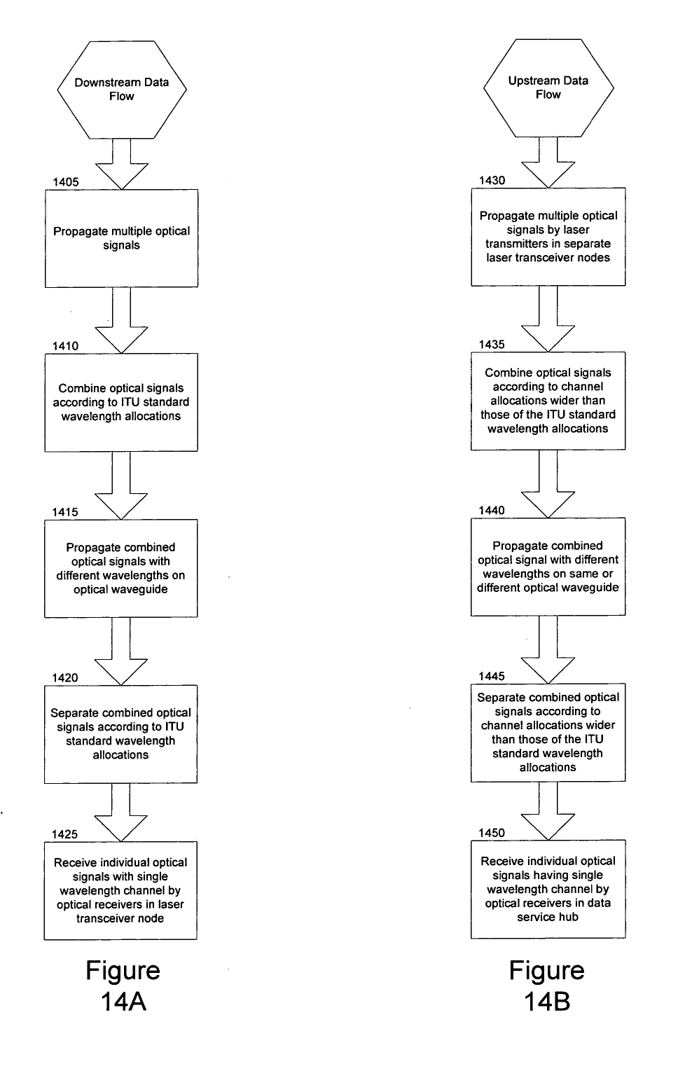

FIGS. 14A-B illustrate a method of implementing an exemplary embodiment of the inventive system 300. In step 1405, multiple signals are propagated by the data service hub 310. In step 1410, these signals are combined with other signals in a MUX/DMUX 315, where the MUX/DMUX 315 is designed according to the ITU wavelength allocations. In step 1415, the combined signals are propagated along a downstream optical waveguide 370. The signals then arrive at a MUX/DMUX 315 or D/A device 700 in step 1420. Here, the signals are de-multiplexed or “dropped,” depending on the device. In any case, the particular device employed is designed according to a wavelength allocation corresponding to the ITU standard. In step 1425, the signals are then received by the laser transceiver node 320.

The upstream process is described in FIG. 14B in steps 1430-1450. While these steps sequentially follow other steps in the flow chart, it is understood by one of ordinary skill in the art that steps 1430-1450 could occur simultaneously, before, or after, steps 1405-1425. Thus, the particular order or sequence of steps 1430-1450 should not be viewed as a limitation of the inventive system 300.

In step 1430, one or more laser transceiver nodes 320 transmit an optical signal. These signals are then multiplexed by a MUX/DMUX 315 in step 1435. Notably, the MUX/DMUX 315 is designed according to a channel allocation that is wider than the downstream standard allocation. In step 1440, the multiplexed signal is sent upstream on an optical waveguide. Importantly, the optical waveguide may be the same as the one carrying the downstream data from the data service hub 310, or it may be a completely different one. That is, the upstream data may or may not be carried on the same waveguide as the downstream data is carried. Accordingly, either optical waveguide 370 or an additional optical waveguide 380 may be utilized in step 1440. In step 1445, the signals are separated on a MUX/DMUX 315 designed according to wavelength allocations wider than the ITU standard. In step 1450, the optical signals enter the data service hub 310 and are received by the optical receivers 470.

Thus, the above described embodiments encompass an optical fiber system that is capable of propagating optical signals to and from a data service hub 310 to a laser transceiver node 320 in which the laser transceiver node 320 is capable of being subjected to extreme temperatures. As described above, it is common for a data service hub 310 to be located in an environment suitable for humans to work; therefore, the equipment operating temperature range is relatively small. Because of this, the wavelengths produced by the optical transmitters 425 (as illustrated in FIG. 4) do not tend to vary outside of the pre-defined ITU standard. However, a laser transceiver node 320 may at times be placed where it is subject to a wide temperature range. In extreme temperatures, the optical waveguide transceiver 530 (as illustrated in FIG. 5) of the laser transceiver node 320 will exhibit a wider wavelength variability. This necessitates operating a novel and unconventional bidirectional communications system 300 that comprises wider upstream channels than its corresponding downstream channels.

Several exemplary embodiments herein have been illustrated to assemble practical optical networks comprising wideband return optical channel widths. These exemplary embodiments, while illustrated with standard ITU wavelength allocations in the downstream direction, may be implemented with any wavelength allocation in the downstream direction. Further, while the upstream communication channel has been defined in the above examples as being roughly twice the width of the ITU wavelength width, this also may be altered without leaving the spirit and scope of the present invention. For example, a laser transceiver node 320 may be located in a climate that is not be subject to the extreme conditions necessary for a wavelength channel twice the width of the ITU channel. For these climates, a wavelength channel of approximately 1.5 times the ITU channel width may be deemed sufficient to accommodate the drift associated with that particular climate's temperatures. Accordingly, the MUX/DMUX 315 and A/D device 700 may be designed for the appropriate wavelength allocation plan consistent with the spirit and scope of the present invention.

Similarly, other variations may be called for where some laser transceiver nodes 320 are subject to extreme temperatures and others are not. In this scenario, the inventive system 300 may be designed such that broad channel widths accompany those laser transceiver nodes 320 subject to extreme temperatures and, for those not subject to the extreme temperatures, a common width channel—such as the ones defined in the ITU standard—may be utilized. Accordingly, one of ordinary skill in the art will appreciate the numerous and varying combinations of channel allocations that may be utilized without departing from the scope and spirit of the present invention.

Therefore, the above exemplary embodiments illustrate various implementations of the inventive system 300. Although specific embodiments of the present invention have been described above in detail, these descriptions are merely for purposes of illustration. Various modifications of the disclosed aspects of the exemplary embodiments, in addition to those described above, may be made by one of ordinary skill in the art without departing form the spirit and scope of the present invention defined in the claims set out below, the scope of which is to be accorded the broadest interpretation so as to encompass such modifications and equivalent structures.

We claim:

1. A system for operating a wideband return channel allocation in a bi-directional optical communication system, comprising:
a first optical transmitter for transmitting a first optical signal on an optical waveguide in a first direction;
a first optical receiver for receiving said first optical signal transmitted on said optical waveguide;
a second optical transmitter for transmitting a second optical signal on said optical waveguide in a second direction, wherein said second direction is the opposite of said first direction;
a second optical receiver for receiving said second optical signal transmitted on said optical waveguide;
an optical multiplexer for multiplexing said first optical signal, said multiplexer designed to multiplex said first optical signal according to a first optical channel width; and
a demultiplexer for demultiplexing said second optical signal, said demultiplexer designed to multiplex said second optical signal according to a second optical channel width, wherein said second optical channel width is wider than said first optical channel width.

2. The system in claim 1, further comprising an optical transmitter for transmitting a radio frequency broadcast video optical signal.

3. The system in claim 2, wherein said radio frequency broadcast video optical signal is transmitted in said first direction along a second optical waveguide.

4. The system in claim 1, further comprising a drop/add device for routing said second optical signal, said drop/add device designed according to said second optical channel width.

5. The system in claim 1, wherein said first optical transmitter is located in a temperature controlled environment.

6. The system in claim 1, wherein said second optical transmitter is located in an uncontrolled temperature environment.

7. The system in claim 1, wherein said second optical channel width is twice the width of said first optical channel width.

8. The system in claim 1, wherein said first optical channel width corresponds to one of the channel widths as defined in the International Telecommunications Union wavelength allocation standard.

9. The system in claim 1, wherein said first optical channel width is 13 nanometers and said second optical channel width is 26 nanometers.

10. The system in claim 1, wherein the optical transmitters comprise distributed feed back lasers.

11. The system in claim 1, wherein the optical transmitters comprise Fabry-Perot Laser Transmitters.

12. The system in claim 1, wherein the optical transmitters comprise Vertical Cavity Surface Emitting Lasers.

13. A system for operating a wideband return channel allocation in a bi-directional optical communication system, comprising:
a first optical transmitter for transmitting a first optical signal on a first optical waveguide in a first direction;
a first optical receiver for receiving said first optical signal transmitted on said first optical waveguide;
a second optical transmitter for transmitting a second optical signal on a second optical waveguide in a second direction, wherein said second direction is the opposite of said first direction;
a second optical receiver for receiving said second optical signal transmitted on said second optical waveguide;
an optical multiplexer for multiplexing said first optical signal, said multiplexer designed to multiplex said first optical signal according to a first optical channel width; and
a demultiplexer for demultiplexing said second optical signal, said demultiplexer designed to multiplex said second optical signal according to a second optical channel width, wherein said second optical channel width is wider than said first optical channel width.

14. The system described in claim 13, further comprising an optical transmitter for transmitting a radio frequency broadcast video optical signal in said first direction on said second optical waveguide.

15. The system in claim 13, further comprising a drop/add device for routing said second optical signal, said drop/add device designed according to said second optical channel width.

16. The system described in claim 13, wherein said first optical transmitter is located in a temperature controlled environment.

17. The system described in claim 13, wherein said second optical transmitter is located in an uncontrolled temperature environment.

18. The system described in claim 13, wherein said second optical channel width is twice the width of said first optical channel width.

19. The system described in claim 13, wherein said first optical channel width corresponds to one of the channel widths as defined in the International Telecommunications Union wavelength allocation standard.

20. The system described in claim 13, wherein said first optical channel width is 13 nanometers and said second optical channel width is 26 nanometers.

21. A method for propagating a wideband return channel allocation in a bi-directional optical communication system, comprising the steps of:
transmitting a first optical signal from a first optical transmitter on an optical waveguide in a first direction;
multiplexing said first optical signal according to a first optical channel width;
transmitting a second optical signal from a second optical transmitter on said optical waveguide in a second direction, wherein said second direction is the opposite of said first direction;
demultiplexing said second optical signal according to a second optical channel width, said second optical channel width is wider than said first optical channel width.

22. The method according to claim 21, further comprising the steps of:
demultiplexing said first optical signal according to said first optical channel width; and
multiplexing said second optical signal according to said second optical channel width.

23. The method according to claim 21, further comprising the steps of:
routing said first optical signal with a first drop/add device, said first drop/add device designed according to said first optical channel width.
routing said second optical signal with a second drop/add device, said second drop/add device designed according to said second optical channel width.

24. The method according to claim 21, further comprising the steps of:
broadcasting a radio frequency broadcast optical signal from a third optical transmitter;
amplifying said radio frequency broadcast optical signal with an amplifier;
propagating said radio frequency broadcast optical signal in said first direction along a second optical waveguide.

25. A method for propagating a wideband return channel allocation in a bi-directional optical communication system, comprising the steps of:
transmitting a first optical signal from a first optical transmitter on a first optical waveguide in a first direction;
multiplexing said first optical signal according to a first optical channel width;
transmitting a second optical signal from a second optical transmitter on a second optical waveguide in a second direction, wherein said second direction is the opposite of said first direction;
demultiplexing said second optical signal according to a second optical channel width, said second optical channel width is wider than said first optical channel width.

26. The method according to claim 25, further comprising the steps of:
demultiplexing said first optical signal according to said first optical channel width; and
multiplexing said second optical signal according to said second optical channel width.

27. The method according to claim 25, further comprising the steps of:
routing said first optical signal with a first drop/add device, said first drop/add device designed according to said first optical channel width.
routing said second optical signal with a second drop/add device, said second drop/add device designed according to said second optical channel width.

28. The method according to claim 25, further comprising the steps of:
broadcasting a radio frequency broadcast optical signal from a third optical transmitter;
amplifying said radio frequency broadcast optical signal with an amplifier;
propagating said radio frequency broadcast optical signal in said first direction along said second optical waveguide.
